(19) United States
(12) Patent Application Publication
(10) Pub. No.: US 2020/0259551 A1
(43) Pub. Date: Aug. 13, 2020

(54) Wireless Multi-Media Communication Device and Method of Using

(71) Applicant: PAUL LEONIDAS DEITZ, DICKINSON, TX (US)

(72) Inventor: PAUL LEONIDAS DEITZ, DICKINSON, TX (US)

(21) Appl. No.: 16/873,471

(22) Filed: Apr. 16, 2020

Related U.S. Application Data
(60) Provisional application No. 62/920,624, filed on May 9, 2019.

(51) Int. Cl. H04B 7/155; H04L 29/06

(52) U.S. Cl. CPC H04B 7/155; H04L 69/08

(57) ABSTRACT

A device receives information transmitted over a range of radio frequency bands and rebroadcasts the information by Wi-Fi or cabling to any number of Wi-Fi or cable-compatible devices. For information broadcast at OTA DTV or Wi-Fi frequencies, the device demodulates, amplifies, and transmits the same information wirelessly or by wire. When stationary, the device detects a nearby Wi-Fi AP or Gateway/Controller operating at 2.4 or 5 GHz and connects according to a preprogrammed protocol. When in a moving vehicle, the device when previously connected to an AP or Gateway/Controller, detects contiguous APs or Gateway/Controllers along the route, and then seamlessly connects to the next available. The invention further relates to selecting and activating among numerous available programs those the user wants to purchase or subscribe to via a user interface by communicating with the device either wirelessly or tethering to a smart device.

### CROSS-REFERENCE TO RELATED APPLICATIONS

This application claims the benefit of U.S. Provisional Application No. 62/920,624, filed May 9, 2019.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING.”

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This disclosure relates generally to stationary and mobile electronic devices that receive information broadcasted over a broad range of radio frequencies and rebroadcasts the information via Wi-Fi or cabling to a host of smart devices.

This invention further relates to supplying electrical power to the device by way of an internal battery supplemented by an AC-powered transformer with AC-to-DC rectification, low voltage DC, USB connection, power over Ethernet, or solar panel.

The invention still further relates to a method of selecting and activating among numerous available programs that the user wants to purchase or subscribe to via a user interface by communicating with the device either wirelessly or tethered connection.

Acronyms and terms of art used in this disclosure are defined in the Glossary of Terms subsection.

### 2. The Current State of the Art

(a) Multi-Band Electronic Devices.

There are few stationary or mobile devices that receive information broadcasted over multiple radio frequency bands and then rebroadcast the information to another device compatible with the Institute of Electrical and Electronics Engineers (IEEE) 802.3 (wired Ethernet), IEEE 802.11 (Wi-Fi), or IEEE 802.15 (Bluetooth) standards. Those devices that receive, but do not retransmit, information typically operate within limited radio frequency bands. For example, smart-phones communicate over cellular frequency bands, other devices receive over-the-air digital television (OTA DTV) signals at various VHF and UHF frequency bands, and smart devices, such as laptop and tablet computers, communicate wirelessly via Wi-Fi frequencies. With the exception of Wi-Fi repeaters and some OTA DTV transceivers, none of the devices operating within limited radio frequency bands rebroadcast signals to other devices compatible with IEEE 802.3, IEEE 802.11, or IEEE 802.15 standards.

For OTA DTV, information, in the form of audio and video, is broadcast over a host of radio frequencies; ranging from 54 MHz to 806 MHz. For Wi-Fi, information is transmitted wirelessly at 2.4 GHz and 5 GHz; the two of the more common frequencies. Information may also be transmitted by cellular telephones at 2G, 3G, and 4G LTE frequencies ranging from 800 MHz-5200 MHz.

When using wireless electronic devices inside buildings, in stationary or moving vehicles, or in remote areas, access to OTA DTV, Wi-Fi, and/or cellular phone service, is sometimes limited due to signal strength or interference. Although OTA DTV transmission towers or Wi-Fi access points are nearby, the signal strength may be too weak or interference too strong to connect to devices inside the living space.

The wide variety of frequencies for carrying information routinely requires separate tuned antennas and receiving devices; each designed to capture the signal transmitted at the OTA DTV, Wi-Fi, or cellular phone frequencies. If signal strength is poor, users must sometimes mount the antennas outside, with separate cabling to individual receiving devices inside the living space. For example, to capture OTA DTV signals, a consumer may use an antenna comprising “rabbit-ears” mounted on top of the television or an antenna fixed to the roof of a residence. Information transmitted by Wi-Fi relies on an indoor router with multiple small antennas. Information transmitted by cellular telephone is received via an antenna contained within the phone itself.

Some of the electronic devices that operate within limited frequency bands may communicate while mobile; but typically are designed and provisioned for stationary use. If such mobile devices exist at all, they rely on the long range transmission of say an OTA DTV broadcast from a transmission antenna or cellular handoff technology, both well-known to persons with skill in the art. Depending on signal strength, a mobile user could watch OTA DTV while en route. In most cases, the OTA DTV signal is not rebroadcast to other devices which are IEEE 802.3, 802.11, or 802.15 compatible. Roaming Wi-Fi may be accessible to a user if he or she has a mobile Wi-Fi hotspot connected via cellular backhaul. But as detailed below, connecting to the Internet via cellular backhaul has numerous disadvantages.

Currently, there is no single device for receiving information transmitted via OTA DTV, Wi-Fi, and cellular phone frequencies, to amplify and convert the OTA DTV signal to an IEEE 802.11 compatible frequency, amplify the signal already received via an IEEE 802.11 frequency, and to wirelessly or by cabling transmit the information to a host of smart devices compatible with the IEEE 802.3, 802.11, or 802.15 standards located in the living space.

There is a need in the marketplace for a stationary and mobile electronic device that receives information broadcasted over a broad range of radio frequencies and then rebroadcasts the same information to any number of other devices via cabling or Wi-Fi compatible with IEEE 802.3, 802.11, or 802.15 standards.

(b) Reception and Rebroadcast of OTA DTV Signals.

OTA DTV is free, but is limited to the broadcast range of the signal from the transmission tower, typically 30 miles. But the actual range may be more or less, depending on transmission frequency, terrain, location and type of the user's antenna, and electronic interferences. OTA DTV broadcasts are in VHF and UHF frequencies; with the majority in UHF. Antennas suitable for analog TV signals are also suitable for digital TV, if the signal is strong enough.

To compensate for the difficulties in receiving quality OTA DTV, consumers resort to external antennas. Optimal reception is only achieved with an outdoor antenna, mounted at the highest point of a residence, building, boat, or other structure, and using an antenna with relatively high gain. Outdoor antennas detract from the appearance of the structure and specialized tools and techniques are required for installation and aiming.

Limitations associated with outdoor antennas have led to an increased use of indoor antennas. But many consumers are unsatisfied with the reception received using indoor OTA DTV antennas because of inhibiting factors; including: (1) attenuation through the building's walls, (2) bouncing of signals within the room, and (3) interference from other indoor electronic devices.

Another challenge with indoor antennas is the inability to receive all the available OTA DTV stations from a single antenna location. An example of this difficulty is when an antenna is only able to receive one particular TV station in one room, while only able to receive another TV station in another. This may be an effect of multipath, or signal bouncing, in which the same desired signal may enter the antenna from different paths, and the multiple signals corrupt or cancel out one another for that particular channel. Consumers compensate by selecting a compromise location that still leaves one or more desired OTA DTV stations unavailable.

There is a need in the marketplace for a stationary and mobile electronic device that receives information broadcast at OTA DTV frequencies without the need for an outdoor antenna and that rebroadcasts the same information to any number of other devices via cabling or Wi-Fi.

(c) Reception and Rebroadcast of Wi-Fi in a Stationary Environment.

Similar reception issues arise with information transmitted at IEEE 802.11 compatible frequencies. The most common IEEE 802.11 frequency bands are 2.4 GHz and 5 GHz; which are typically transmitted via a dual-band router creating a wireless network access point (AP). At 2.4 GHz, the transmitted signal has a range of about 65 feet indoors and 300 feet outdoors unobstructed and at 5 GHz, about one-half (½) to two-third (⅔) of these distances. To overcome the range limitation in both indoor and outdoor environments, multiple APs may be interconnected to create large coverage areas; i.e., a wireless local area network (WLAN). Indoors, Wi-Fi repeaters are sometimes employed to extend the range of the source Wi-Fi signal. These devices receive the 2.4 GHz or 5 GHz signal, amplify it, and rebroadcast it at either of the two frequency bands.

In the stationary environment, Wi-Fi AP detectors inform the consumer that one or more APs are available. To connect to a wireless network, hardware and software on the consumer's device first locates and identifies WLANs within range of their smart phone, laptop, or tablet computer. The available WLANs are identified by their SSIDs, which appear as a list of available wireless networks. The SSID, signal strength icon, and security word, “Open” or “Secured,” help the consumer determine whether a network is intended for public or private use, and if private, whether the consumer has a subscription that would allow him or her to access that particular network. Once located, the consumer connects to the wireless network, which may require an authentication and authorization log-in procedure. This is often a frustrating procedure, because although the consumer may find that wireless networks are in the vicinity, they are privately held and accessible only by subscription and password.

There is a need in the marketplace for a Wi-Fi repeater that can scan available SSIDs, and automatically connect to one of the SSIDs based on pre-programmed signal strength, signal-to-noise ratio (SNR), and security requirements. Then amplify the Wi-Fi signal and rebroadcast the signal wirelessly to other IEEE 802.11 or 802.15 compatible devices or by cabling to other devices that meet IEEE 802.3 standards.

(d) Reception and Rebroadcast of Wi-Fi in a Mobile Environment.

A Wi-Fi repeater connecting to one or more contiguous Wi-Fi access points while the repeater is moving at up to highway or railway speeds creates unique challenges. Current mobile Wi-Fi technology envisions a user connecting his or her laptop or tablet computer to a series of contiguous APs while traveling in an automobile or on a train. But laptop and tablet computers are not equipped or provisioned for Wi-Fi repeating. In this scenario, they are end-use mobile devices.

Existing solutions for end-use mobile Wi-Fi are coupled to either a cellular or satellite network for backhaul access. In recent years, these networks have experienced explosive growth, causing operators to install additional bandwidth to cope with the increased traffic. Much of the explosive growth arises from users accessing Wi-Fi through smart-phone hotspots or laptop computers tethered to mobile hotspots, both connected via a cellular or satellite subscription.

Cellular and satellite backhauls for Wi-Fi access have inherent data bottlenecks that significantly limit the user's experience for streaming video or Internet browsing. The problem is further exacerbated in multi-user environments; when multiple passengers attempt to access external networks via an in-vehicle modem built into the vehicles infotainment or telematics system. Multiple passengers each seek access to the common interface on top of the vehicle's telematics bandwidth needs. These difficulties render consumers riding in vehicles wholly or partly unproductive by virtue of limited bandwidth of the cellular or satellite backhaul, spotty coverage, and/or frequent loss of connection.

From a consumer's standpoint, while cellular and satellite networks provide mobile Wi-Fi service over large coverage areas, they offer significantly less bandwidth than the traditional stationary in-home or in-office Wi-Fi. For the service provider, cellular networks are expensive to deploy, upgrade, and maintain and satellite networks are even more expensive to deploy and virtually impossible to upgrade and maintain in space.

One approach is to move the access to mobile Internet from cellular or satellite backhaul to already existing, or soon to be installed, Wi-Fi APs. The proliferation of accessible Wi-Fi APs along thoroughfares and near shore has made Wi-Fi available to over-the-road vehicles or boats underway or moored. But content delivery for mobile Wi-Fi faces at least three challenges.

First, connection latency is typically high due to probing delays in the search for the next AP. In the United States, in the simplest method of looking for Wi-Fi access, the mobile device is programmed to probe the 11 2.4 GHz channels and the 23 5 GHz non-overlapping channels. But in this method, connection quality may suffer from high loss rates due to control packets required for connection being lost and requiring retransmissions. There may be further delays in acquiring the Internet Protocol (IP) address via Dynamic Host Configuration Protocol (DHCP).

Second, for a mobile device, the hardware and provisioning must provide for a robust handover strategy. Several APs may be accessible at any location along the route. The device must quickly determine which of the available APs is the best one to connect to. The handoff strategy common for stationary Wi-Fi access will not work in the mobile environment. The stationary user first disconnects thereby initiating handoff, next manually searches the available SSIDs, and then chooses the next AP based on signal strength and credentialing requirements. For those using Wi-Fi for VoIP or streaming, disconnecting from the current AP, searching the available APs, and reconnecting to the next AP must be performed in less than 150 milliseconds (ms) to maintain acceptable quality of experience (QoE) service.

Third, a suitable data transfer strategy is required. Historically, mobile Wi-Fi access has been characterized by frequent disconnections and lossy links. These are known to degrade Transmission Control Protocol (TCP) performance, and impact applications requiring session maintenance; e.g., File Transfer Protocol (FTP), Hypertext Transfer Protocol (HTTP), FTP over Secure Sockets Layer (FTPS), or HTTP over Secure Sockets Layer (HTTPS).

To meet the challenges, persons with skill in the art have experimentally investigated various mobile Wi-Fi disconnection and connection techniques for end-use devices. The methods are described as on-line (active probing) or off-line (passive probing). The on-line methods involve having the moving user's end-use Wi-Fi device actively scan for accessible APs. The end-use device is outfitted with hardware and software to scan for the next AP either before, or after, the current connection is broken. These active probing methods are known to require excessive bandwidth and are subject to long latency. In the off-line methods, the user's end-use device is outfitted with hardware and software to probe and map APs over several days or weeks by the user or his or her service provider along known routes. For each probed AP, data is collected which may include, but is not limited to; (1) physical layer information, such as the SNR, (2) link layer information, such as the media access control (MAC) address, identifying name of the wireless network, i.e., extended service set identifier (ESSID), channel, and wireless security information, i.e., Wired Equivalent Privacy (WEP), Wi-Fi Protected Access (WPA), Wi-Fi Protected Access II (WPA2), and/or Wi-Fi Protected Access 3 (WPA3), and (3) network layer information, such as a usable internet protocol (IP) address, default gateway, and domain name system (DNS) server information. Each probed and mapped AP is tagged with the GPS location of the mapping vehicle.

Another method of implementing mobile Wi-Fi uses a Transit AP resident in a moving vehicle, which communicates wirelessly with a Child AP, and the Child AP in turn wirelessly communicating with a Parent AP to reach the service providers backhaul. Although the Transit AP is a Wi-Fi repeater, this method does not contemplate direct communication with a Gateway/Controller and is limited to connections with APs accessible by subscription.

Solutions are needed to extend and enhance wireless network coverage within moving vehicles, trains, or near-shore boats. Specifically, solutions and improvements would enable network providers to support Wi-Fi bandwidths within these modes of transportation, preferably with minimal outlays of capital and/or network infrastructure, with substantial flexibility, and ability to economically upgrade and maintain.

The subject matter discussed in this, and other sections, is not necessarily prior art and should not be assumed to be prior art merely as a result of its presentation. Any recognition of problems in the prior art discussed in this disclosure or associated with such subject matter should not be treated as prior art unless expressly stated to be prior art. Instead, the discussion of any subject matter in this disclosure should be treated as part of the identification of the technological problems to be overcome, which in and of itself may also be inventive.

The present invention solves these problems by providing a single device located in the living space or in a moving vehicle. The user connects to the device wirelessly for programming through a smart-device portal. The device provides access to information transmitted via OTA DTV, IEEE 802.11, or cellular phone frequencies while allowing other compatible user devices to be connected to the device wirelessly or by cabling.

### 3. Description of the Related Art Including Information Disclosed Under 37 C.F.R. 1.97 and 1.98

Although U.S. patents and published patent applications are known which disclose various devices and methods of using such devices for receiving information transmitted at various radio frequencies, converting the information to another frequency, amplifying the signal, and retransmitting the information to a local receiver, no prior art anticipates, nor in combination renders obvious, the invention described herein.

U.S. published patent applications relevant as prior art in the field of converting over-the-air television signals to IEEE 802.11 compatible frequencies include: U.S. Patent Publication No. 2008/0301750, Silfvast, R. D., et al., Networked Antenna and Transport System Unit; U.S. Patent Publication No. 2013/0227619, Lewis, R., Wireless Network Antenna Apparatus and Method; U.S. Patent Publication No. 2015/0201232, Gintis, M. A., Antenna Sub-system for Receiving Multiple Digital Broadcast Television Signals; U.S. Patent Publication No. 2016/0337677, Lee, D-H, Broadcast Receiving Apparatus and Control Method Thereof; and U.S. Patent Publication No. 2018/0184164, Petruzzelli, E. F., et al., Distributed Indoor Antenna System for Over-the-Air Television Reception.

U.S. patents and published patent applications relevant as prior art in the field of wireless access in moving vehicles include: U.S. Pat. No. 9,918,345, Gunasekara, D., et al., Apparatus and method for wireless network services in moving vehicles; U.S. Patent Publication No. 2007/0115900, Liang, M., et al., Method and apparatus for improved voice over internes protocol (VoIP) telephone configuration; U.S. Patent Publication No. 2008/0037493, Morton, P., System and Method for Servicing Communications using both Fixed and Mobile Wireless Networks; U.S. Patent Publication No. 2013/0016648, Koskela; T. K. et al., Connectivity Setup For Dynamic Wireless Mesh Networks; U.S. Patent Publication 2013/0235774, Jo, S-K., et al., Energy-Saving Mobile Node Control Method Using Wireless Multi-Interfaces; U.S. Patent Publication No. 2013/0308622, Uhlik; C., System for On-Demand Access to Local Area Networks; U.S. Patent Publication No. 2017/0208632, Gunasekara, D., et al., Apparatus and Method for Wireless Network Services in Moving Vehicles; and U.S. Patent Publication No. 2018/0279391, Gunasekara, D., et al., Apparatus and Method for Wireless Network Services in Moving Vehicles.

U.S. published patent applications relevant as prior art in the field of repeating signals transmitted via IEEE 802.11 compatible frequencies include: U.S. Patent Publication No. 2010/0074162, Koh; K-K.; et al., Wireless Internet Connection Repeater without Signal Interference; U.S. Patent Publication No. 2012/0182928, Koh; K-K.; et al., Wireless Internet Connection Repeater without Signal Interference; U.S. Patent Publication No. 2013/0242852, Petros, Argy, Portable WiFi Signal Repeater; U.S. Patent Publication No. 2015/0282276, Bates; R. L., Wi-Fi Control; U.S. Patent Publication No. 2016/0149635, Hinman; B. L., et al., Wi-Fi Hotspot Repeater; and U.S. Patent Publication No. 2018/0158309, Steins; K. M., Sound-responsive Repeater Device and System.

### BRIEF SUMMARY OF THE INVENTION

The present disclosure is directed towards a stationary or mobile device with the capability to receive information transmitted over a broad range of radio frequency bands and to rebroadcast the information by Wi-Fi or cabling to other devices.

For the information broadcast at OTA DTV frequencies, the device demodulates, amplifies, and transmits the same information wirelessly to any number of devices compatible with an IEEE 802.11 or 802.15 standard or by High-Definition Multimedia Interface (HDMI), Ethernet compatible with IEEE 802.3 (Ethernet), or Universal Serial Bus (USB) compatible cabling.

For information transmitted via IEEE 802.11 protocols 802.11a, 802.11b, 802.11g, 802.11n, and 802.11ac, the device amplifies and transmits the same information wirelessly to a host of devices compatible with IEEE 802.11 or 802.15 standards, or by HDMI, Ethernet, or USB compatible cabling.

This invention further relates to a device, used in a stationary location that detects nearby Wi-Fi APs or Gateway/Controllers operating in the 2.4 GHz or 5 GHz frequency bands, and connects to an available AP or Gateway/Controller according to a protocol pre-programmed in the device.

This invention still further relates to a device in a moving vehicle previously connected to a Gateway/Controller operating in the 2.4 GHz or 5 GHz frequency bands that, while moving, detects other Wi-Fi APs or Gateway/Controllers operating in the 2.4 GHz or 5 GHz frequency bands along the route traversed by the vehicle, and then connects to the next available AP or Gateway/Controller according to a protocol pre-programmed in the device.

This invention still further relates to supplying electrical power to a device by way of an internal battery supplemented by an AC-powered transformer with AC-to-DC rectification, low voltage DC, USB connection, power over Ethernet, or solar panel.

The invention still further relates to a method of selecting and activating among numerous available programs that the user wants to purchase or subscribe to via a user interface by communicating with the device either wirelessly by smart cellular phone, laptop or tablet computer, or by tethered connection.

These features with other technological improvements, which will become subsequently apparent, reside in the details of construction and operation as more fully described hereafter and claimed, reference being had to the accompanying drawings forming a part hereof.

### BRIEF DESCRIPTION OF THE SEVERAL VIEWS OF THE DRAWINGS

### 1. Brief Description of the Several Views of the Drawings

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

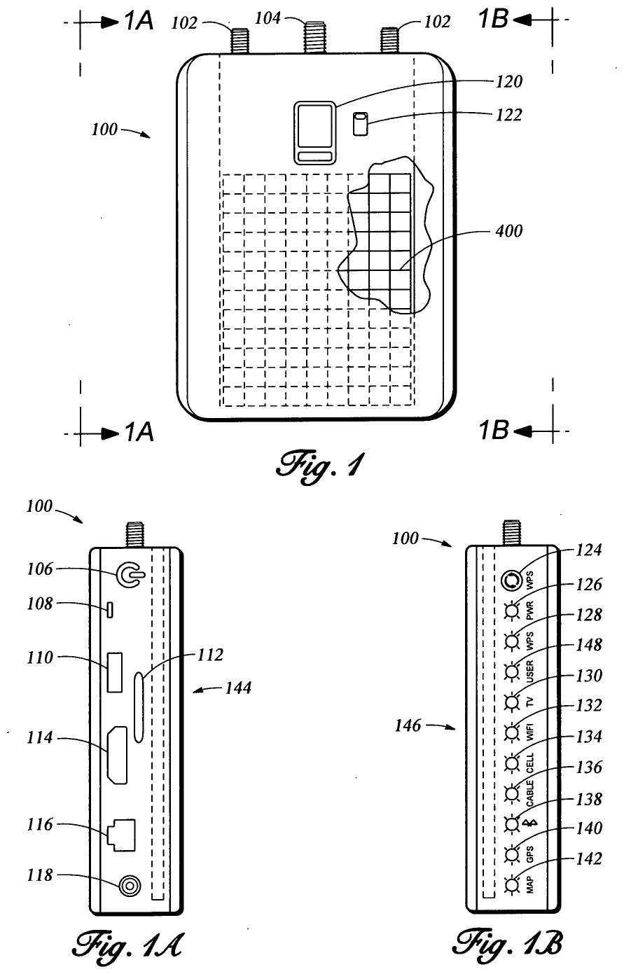

FIG. 1 illustrates the preferred embodiment of the device showing its antennae connection points with its internal solar panel.

FIG. 1A depicts the left side of the preferred embodiment.

FIG. 1B shows the right side of the preferred embodiment.

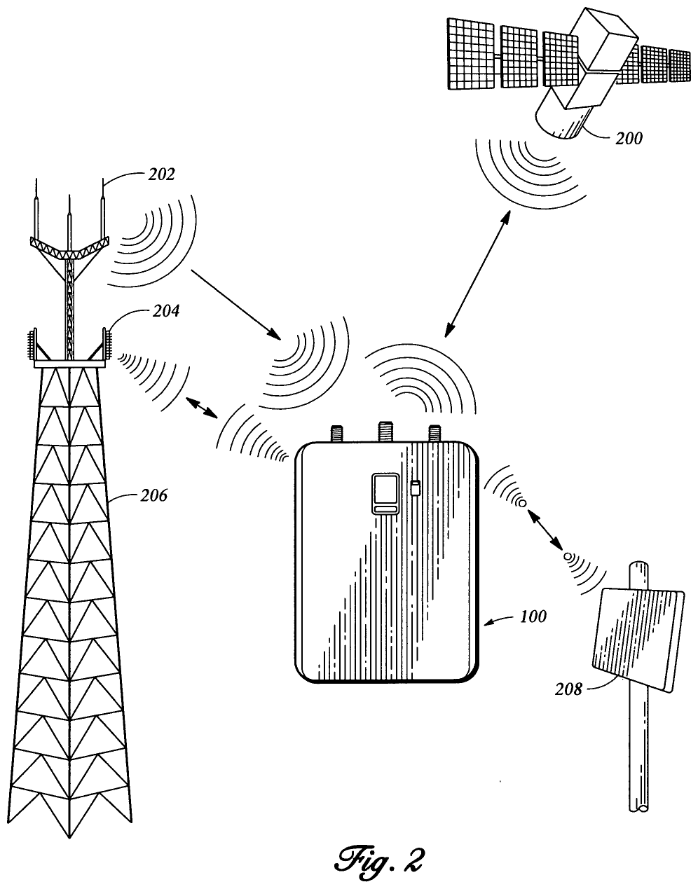

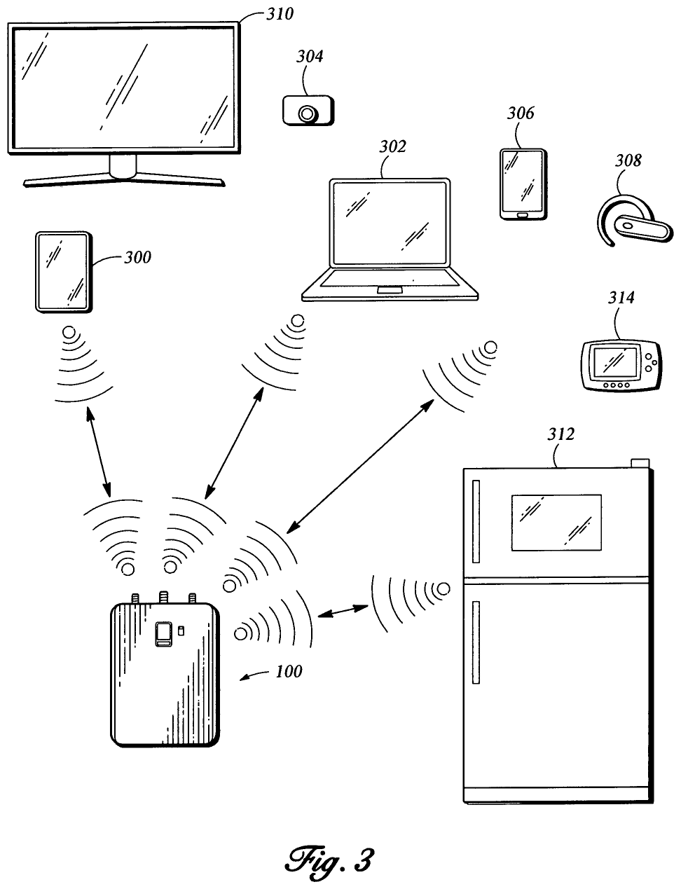

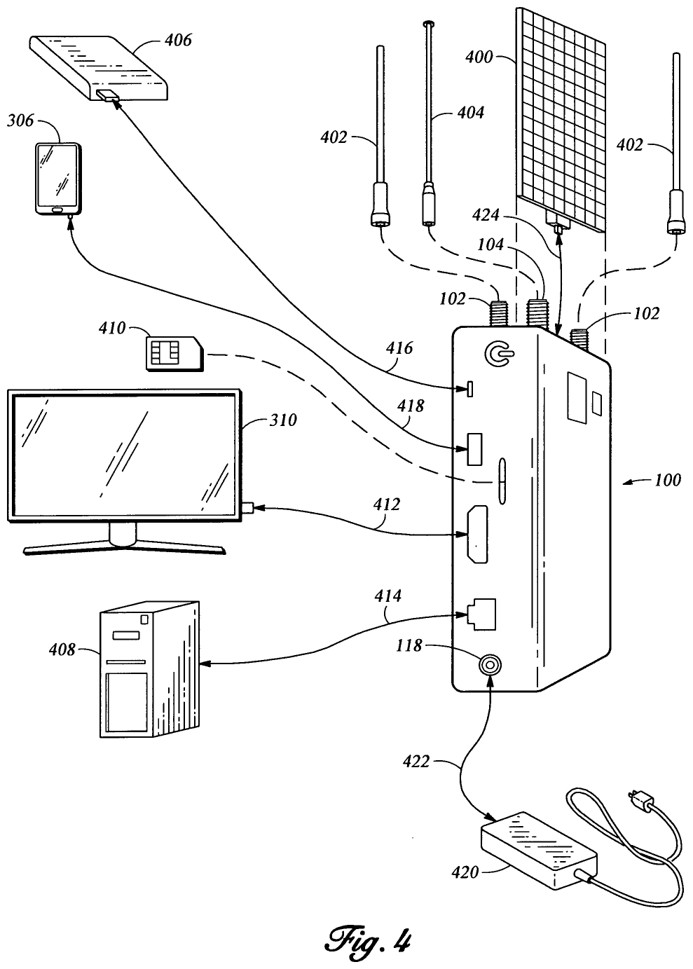

FIG. 2 depicts the preferred embodiment of the device in two-way communication between a dual-band 2.4 GHz and 5 GHz Wi-Fi antenna, and OTA DTV and cellular telephone antennas on a transmission tower, and a GPS satellite.

FIG. 3 shows the preferred embodiment of the device connected wirelessly to Wi-Fi and Bluetooth compatible devices.

FIG. 4 depicts the preferred embodiment of the device with the charging solar panel extended and connected to a series of smart devices via HDMI, micro USB, USB, and Ethernet cabling.

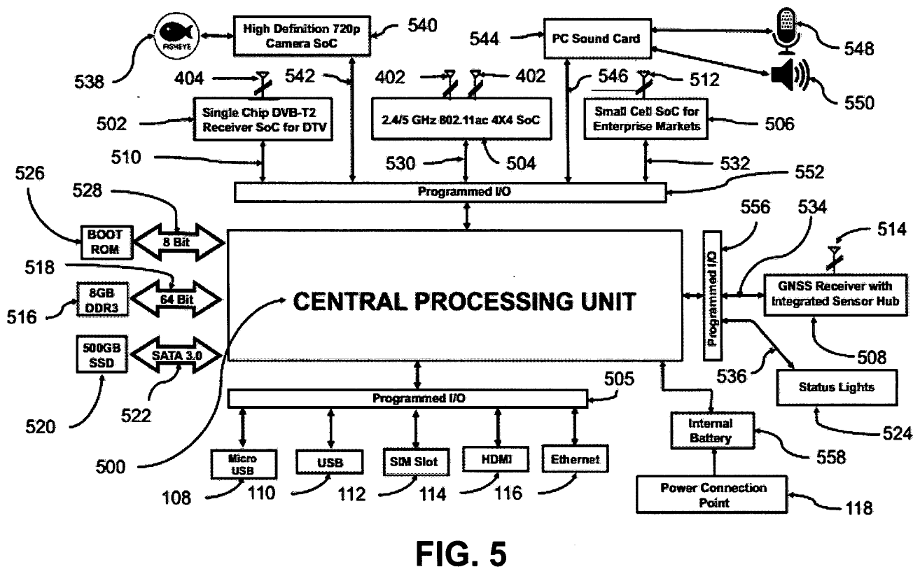

FIG. 5 is a block diagram showing the various hardware components required to enable the functions of the preferred embodiment of the device.

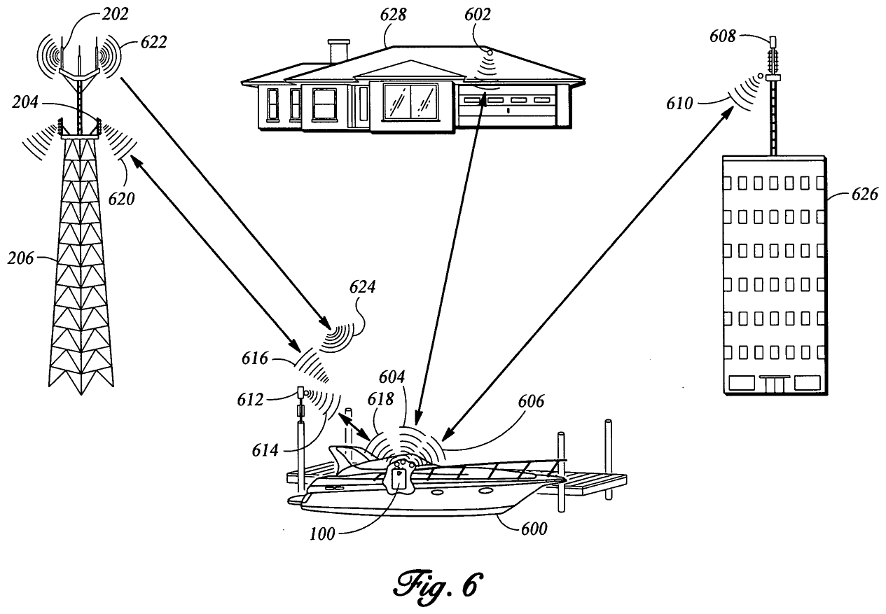

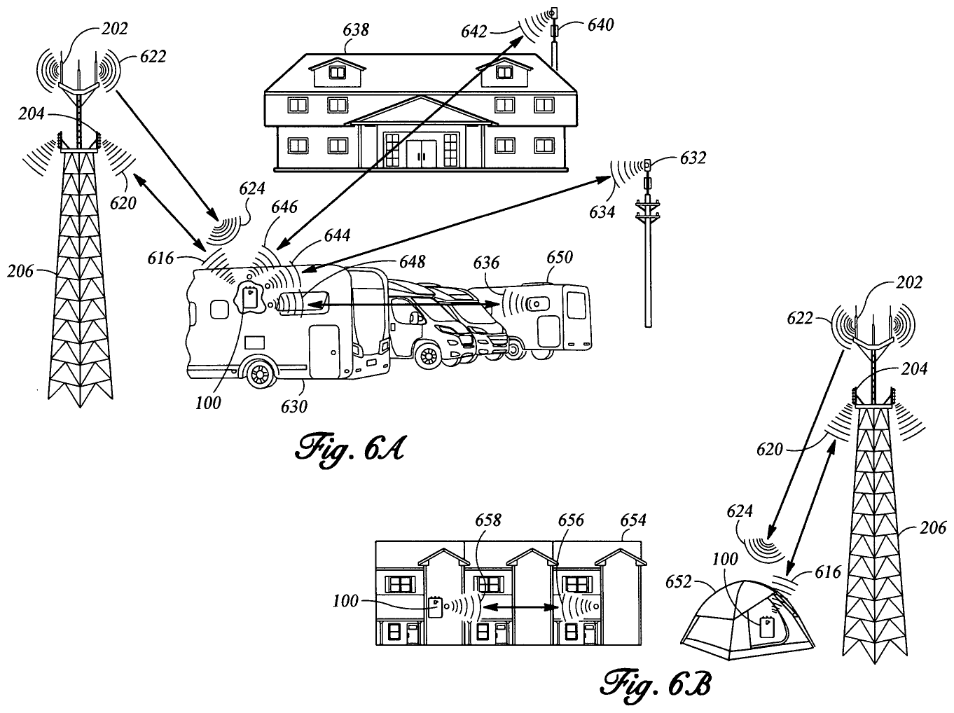

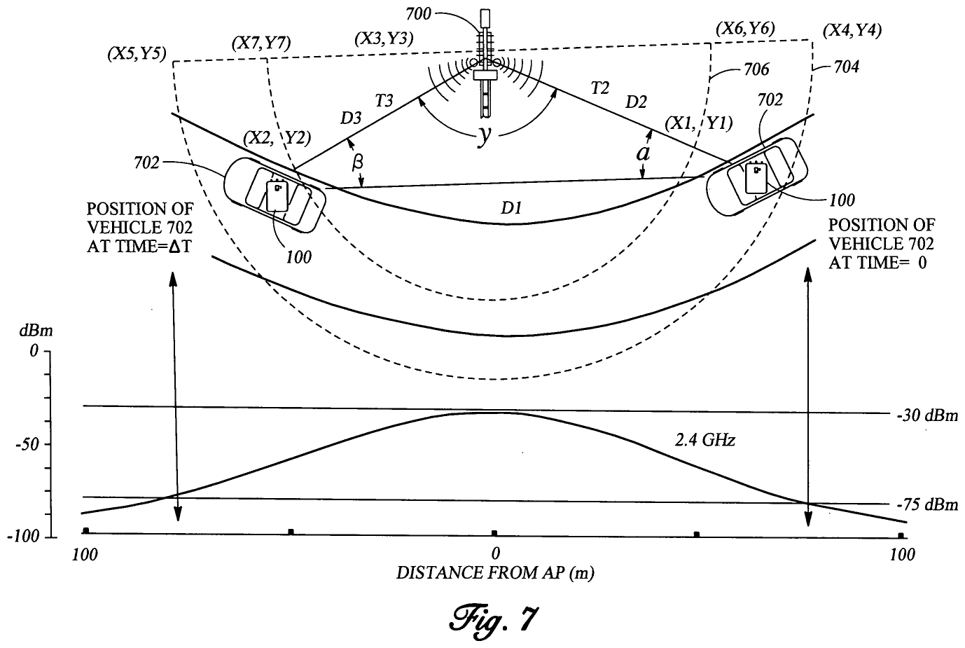

FIG. 6 illustrates the device located in a moored boat in communication with wi-fi APs and hotpots, and OTA DTV and cellular broadcast antennae.

FIG. 6A shows the device in a trailer in a recreational vehicle park in communication with wi-fi APs and hotpots, and OTA DTV and cellular broadcast antennae.

FIG. 6B shows the device in a tent in a remote location in communication with OTA DTV and cellular broadcast antennae and in an apartment in a complex in communication with a wi-fi hot spot in a nearby apartment.

FIG. 7 depicts the device in mapping mode.

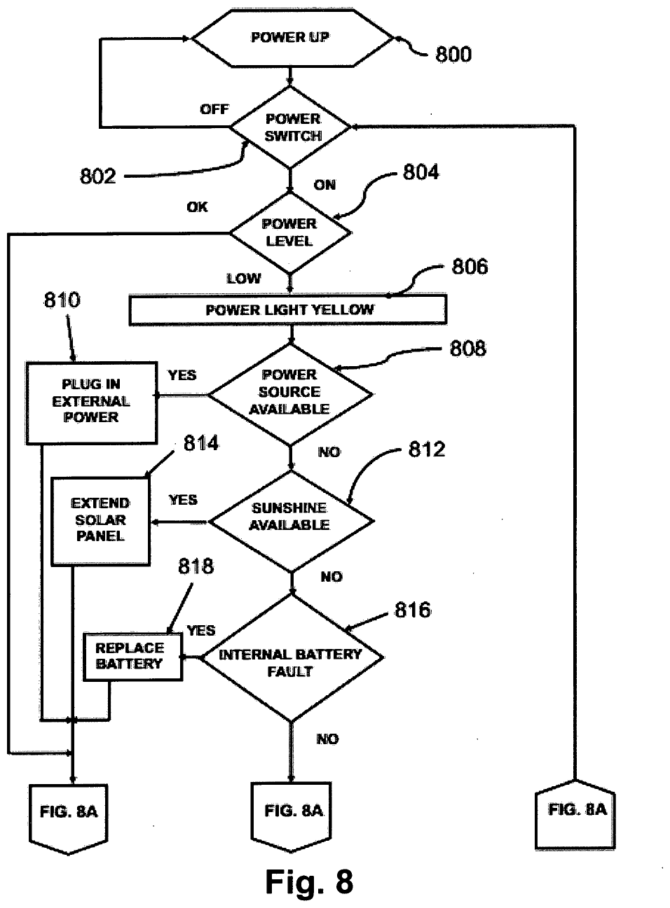

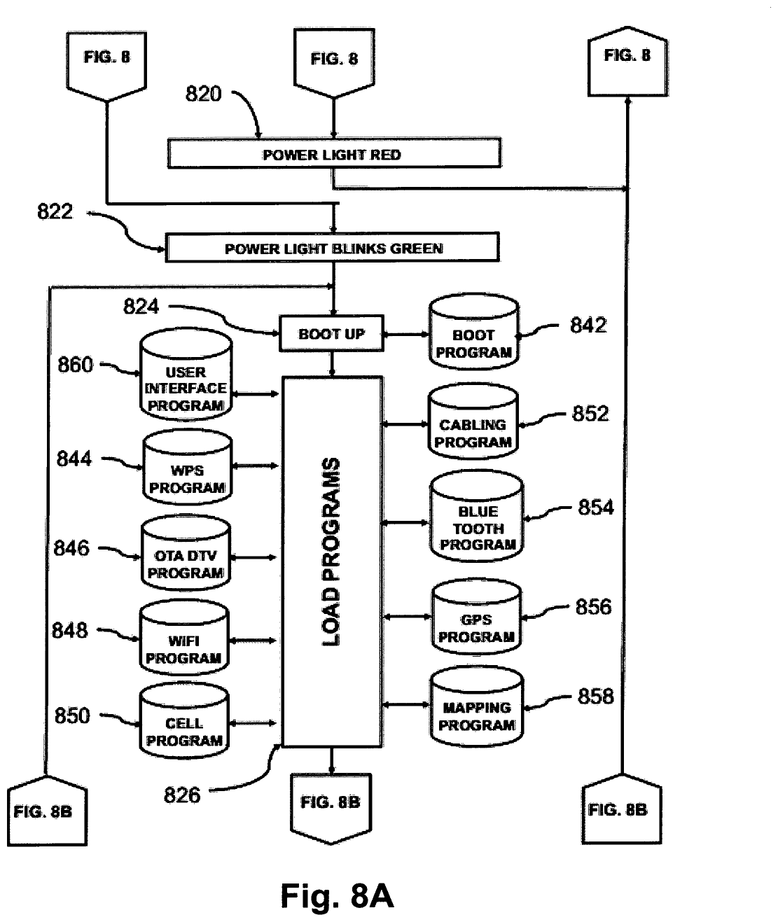

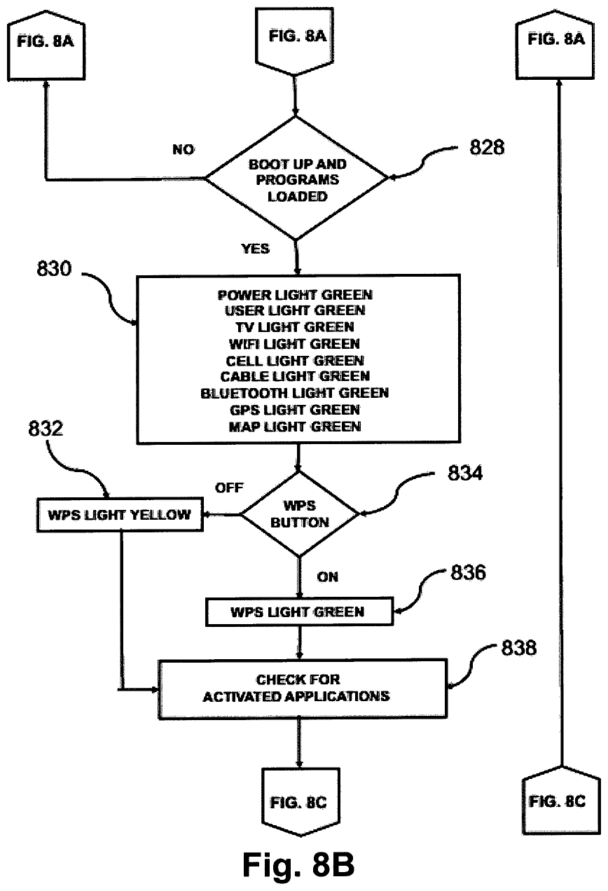

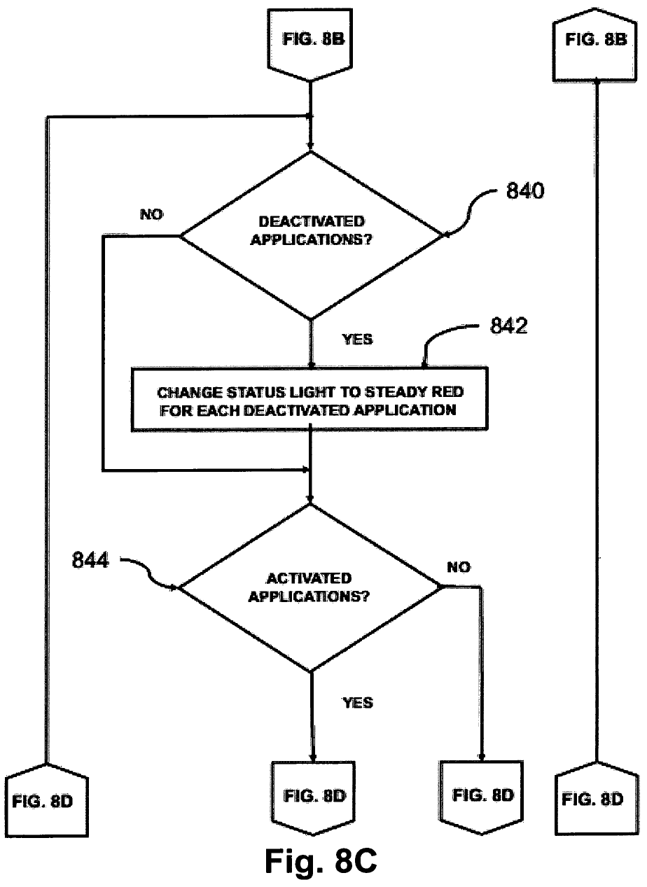

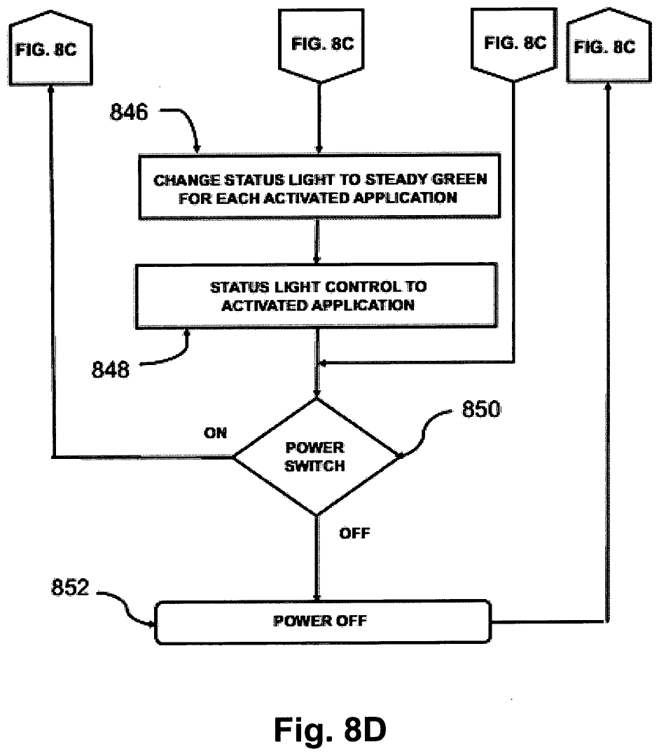

FIGS. 8, 8A, 8B, and 8C is a flow chart showing the initialization sequence for the preferred embodiment.

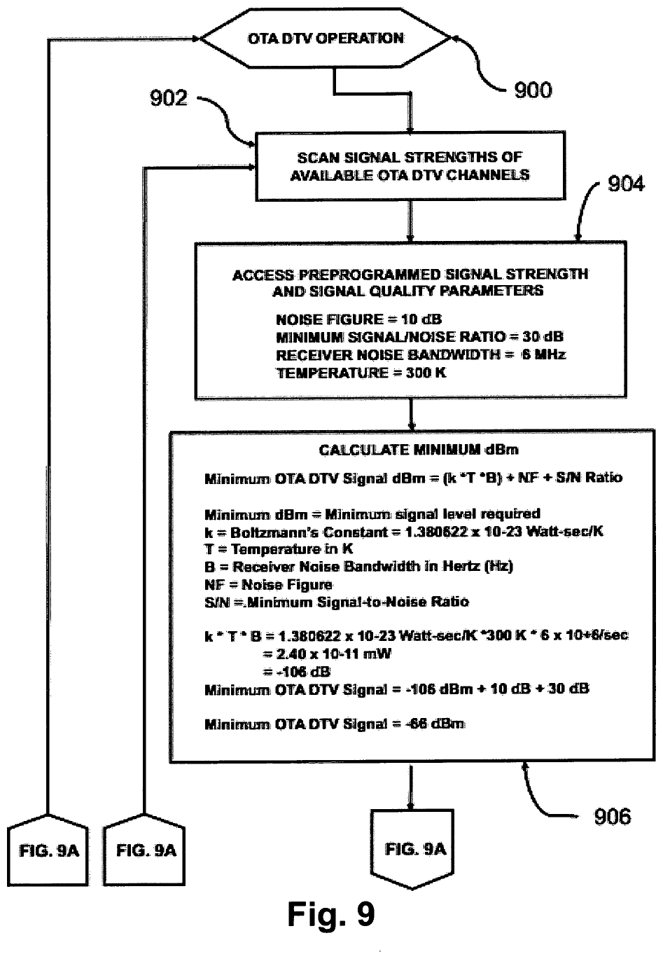

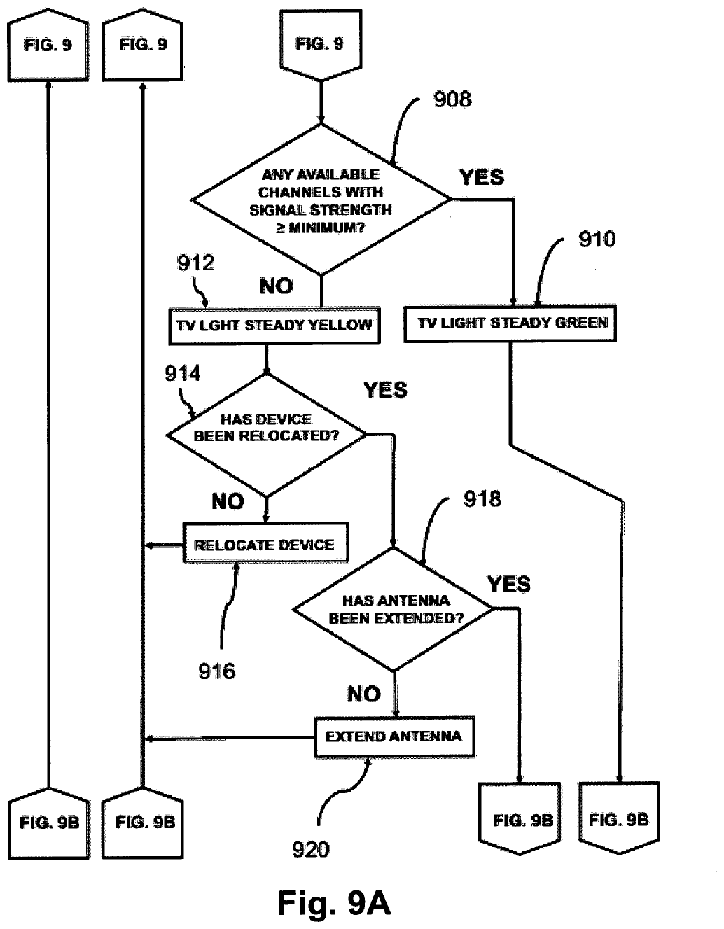

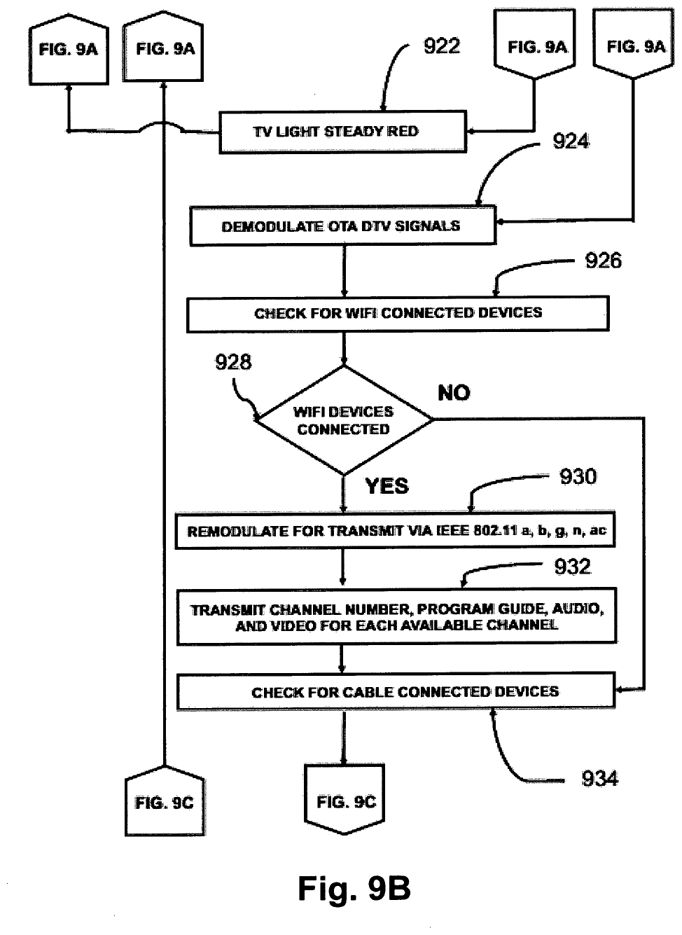

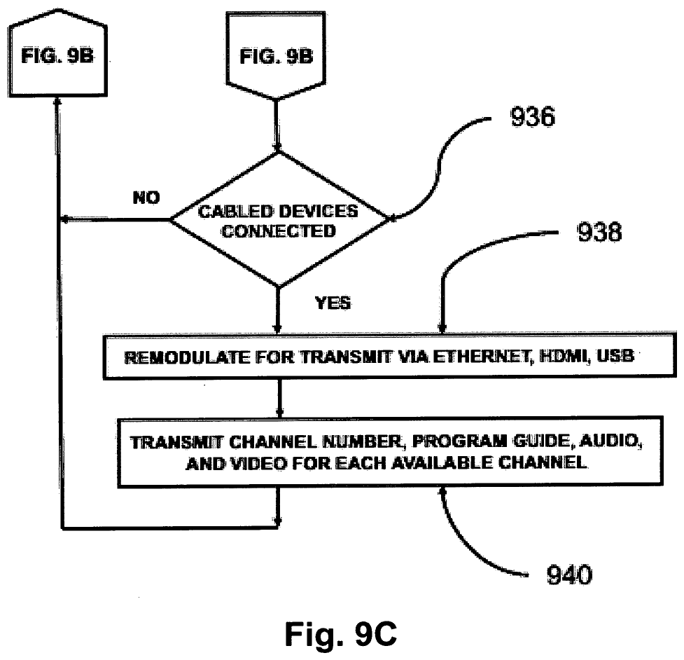

FIGS. 9, 9A, 9B, and 9C is a flow chart depicting operation of the preferred embodiment as an OTA DTV transceiver.

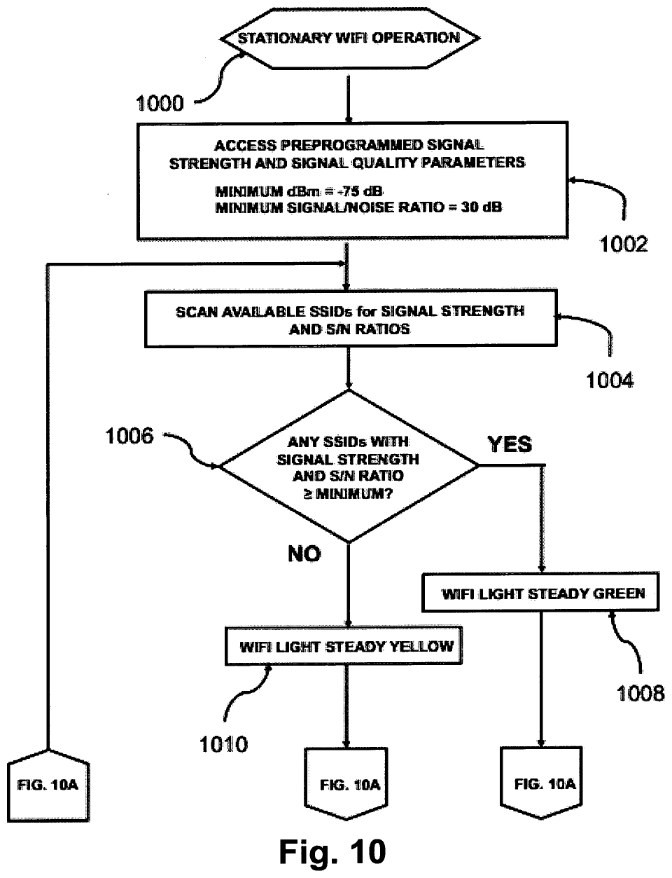

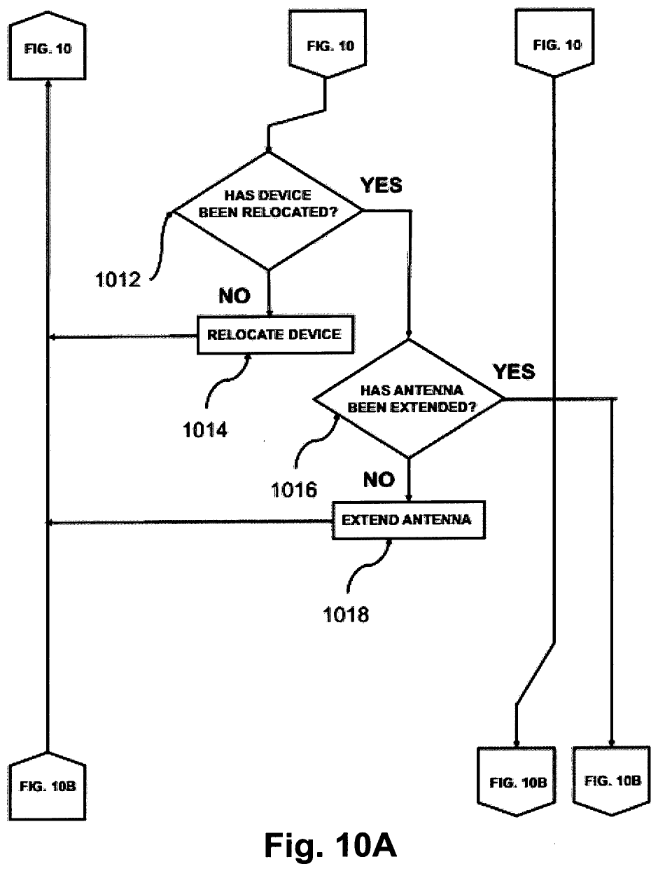

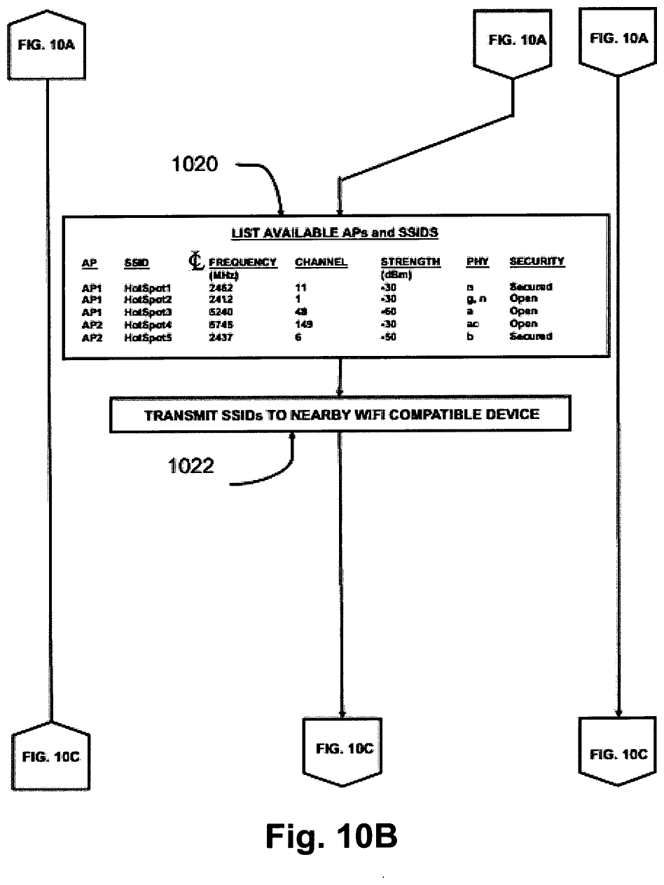

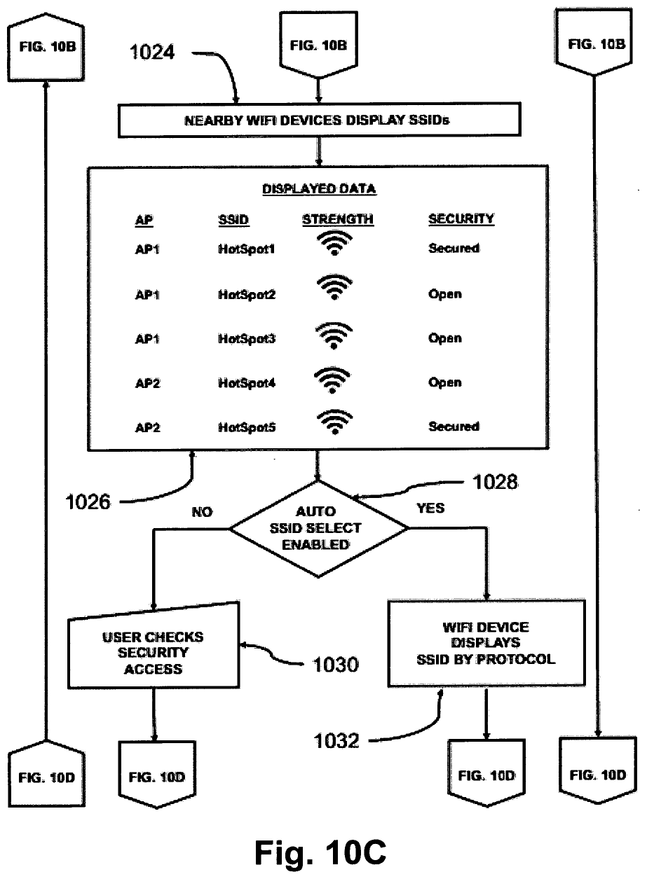

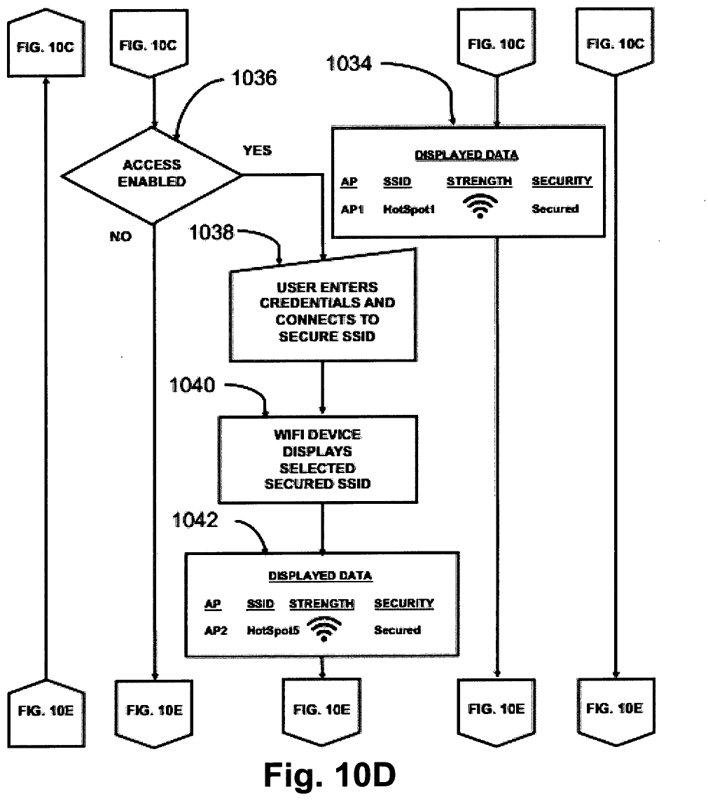

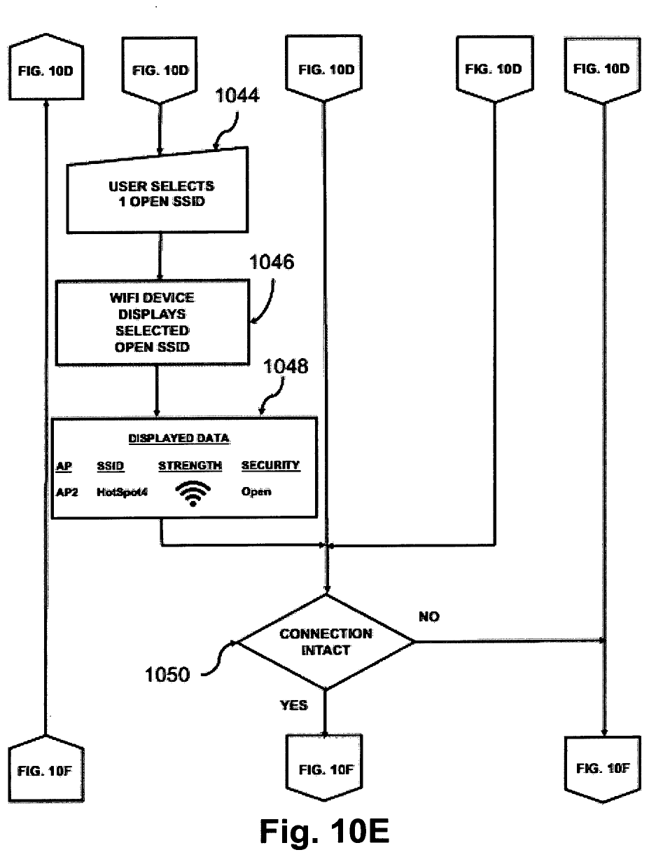

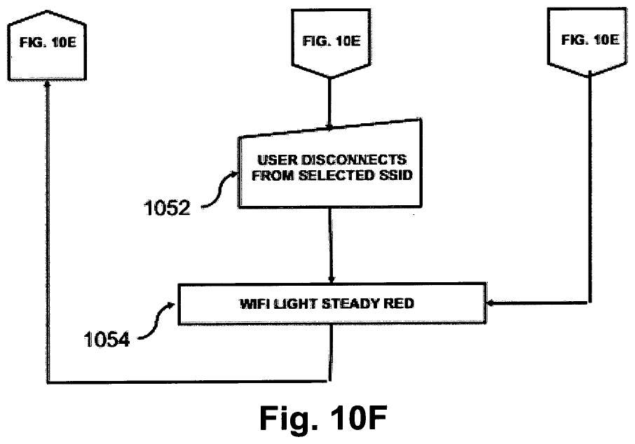

FIGS. 10, 10A 10B, 10C, 10D, 10E, and 10F is a flow chart illustrating operation of the preferred embodiment as a stationary Wi-Fi repeater.

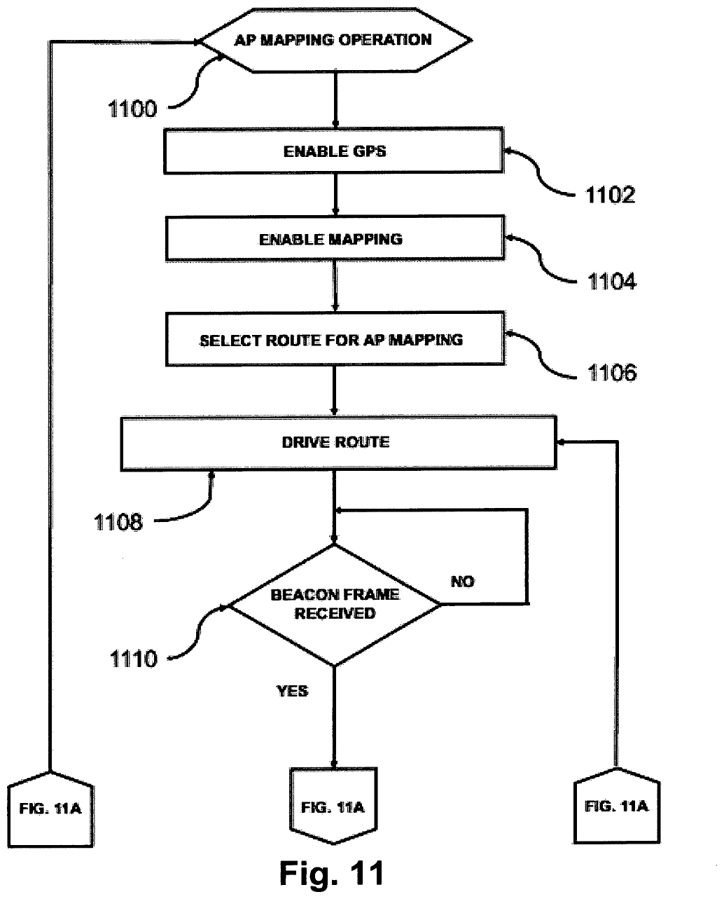

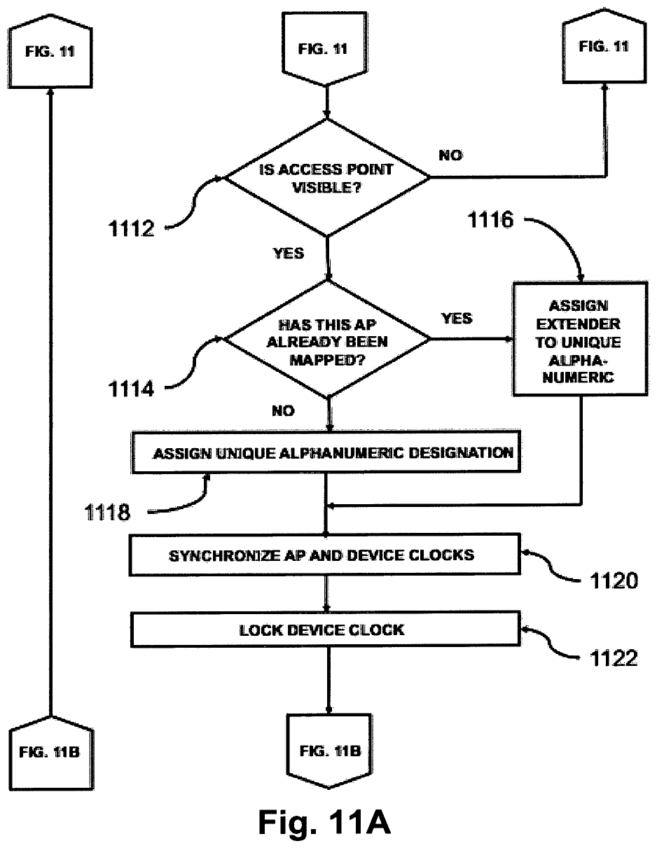

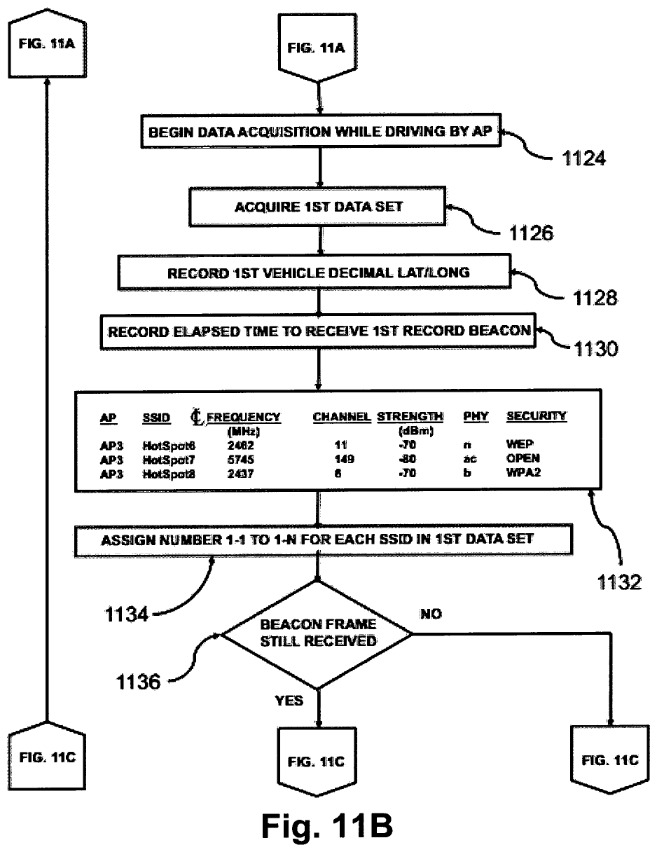

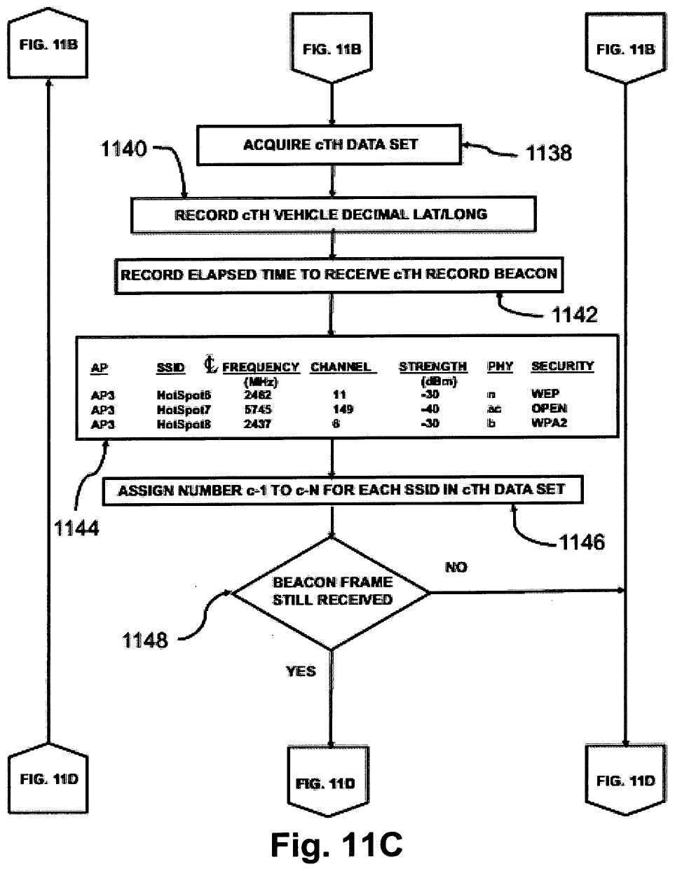

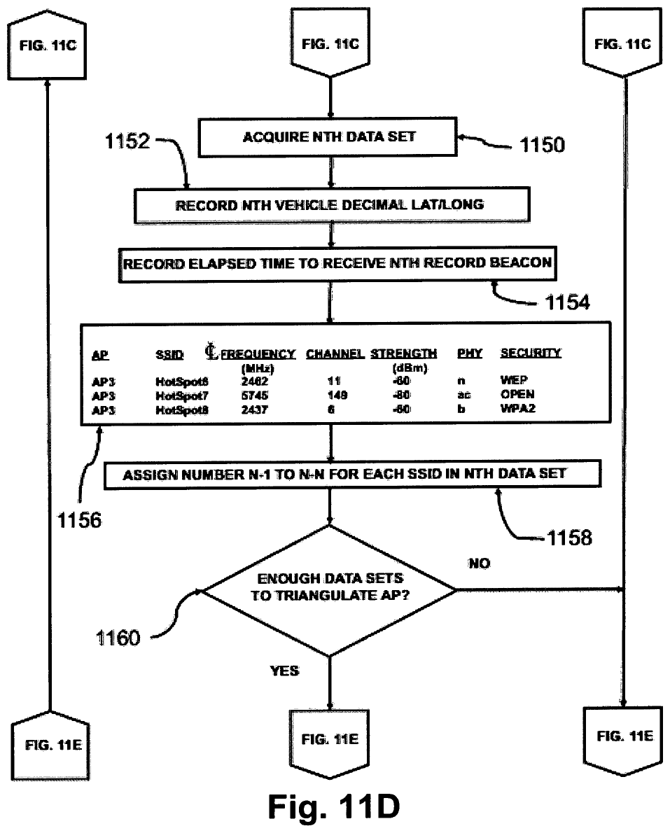

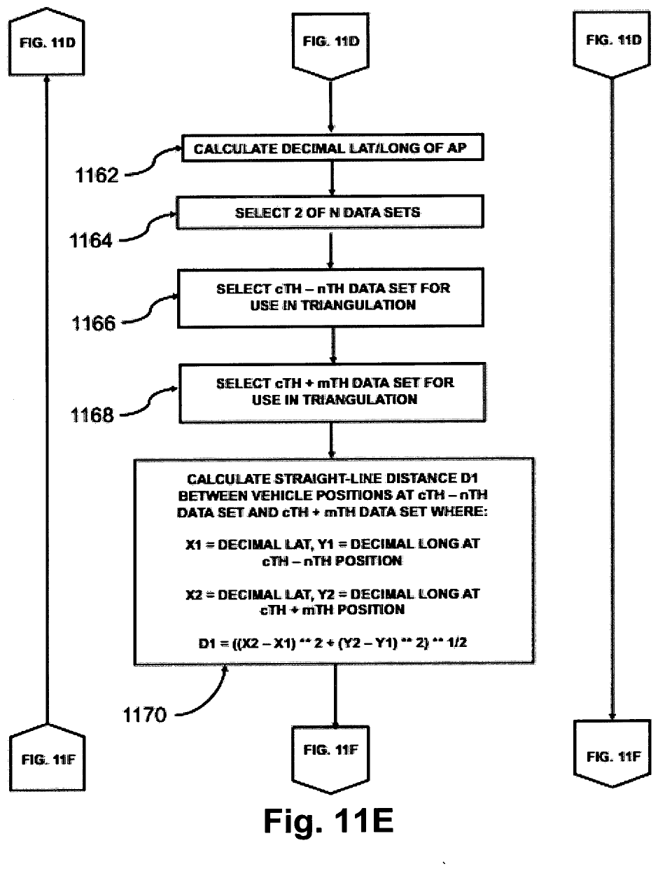

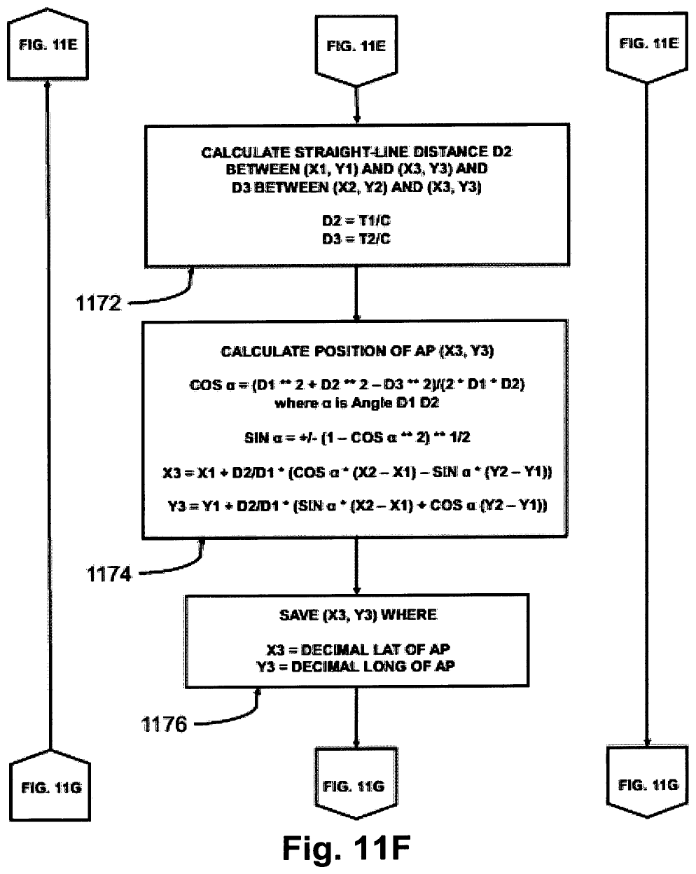

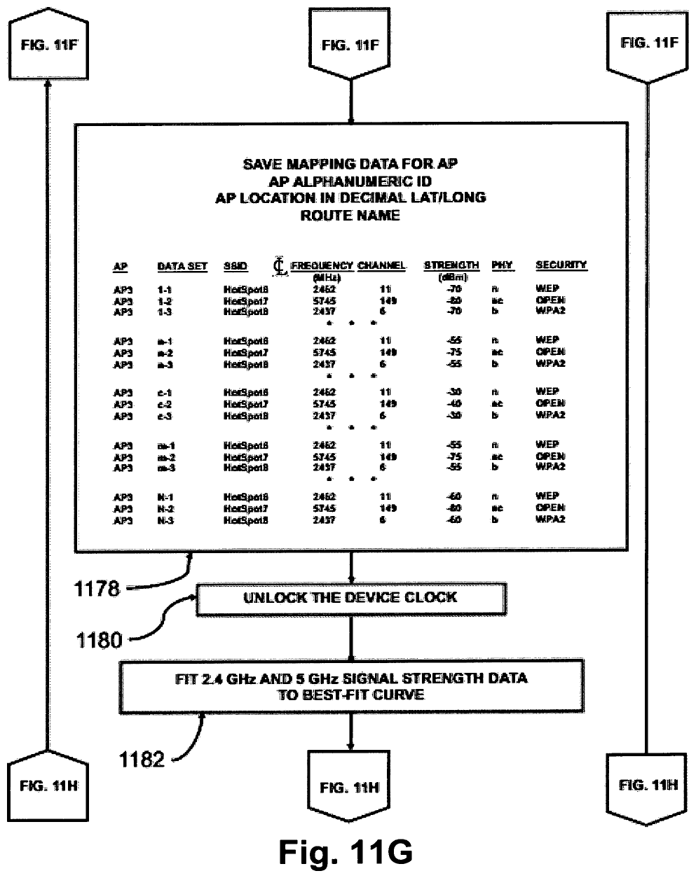

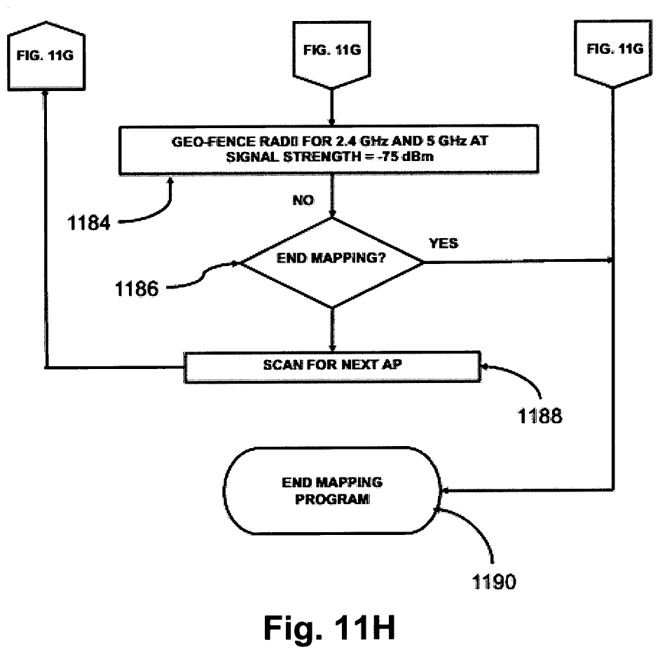

FIGS. 11, 11A, 11B, 11C, 11D, 11E, 11F, 11G, and 11H is a flow chart showing the preferred embodiment operated in mapping mode.

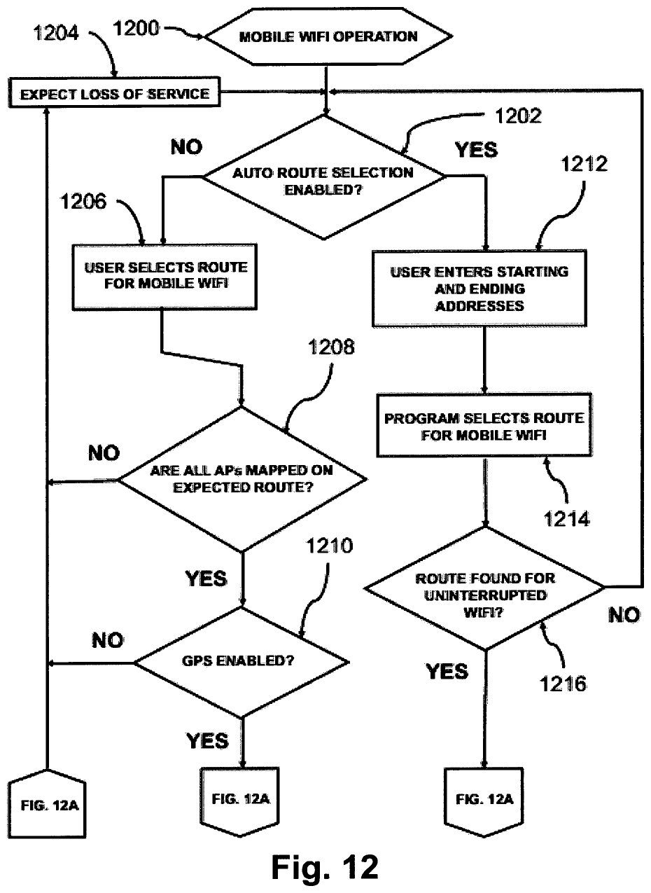

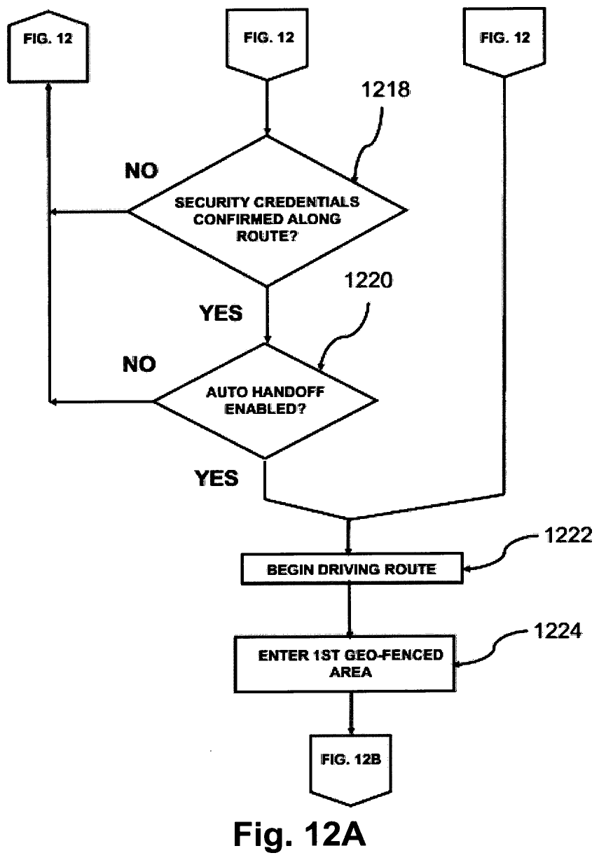

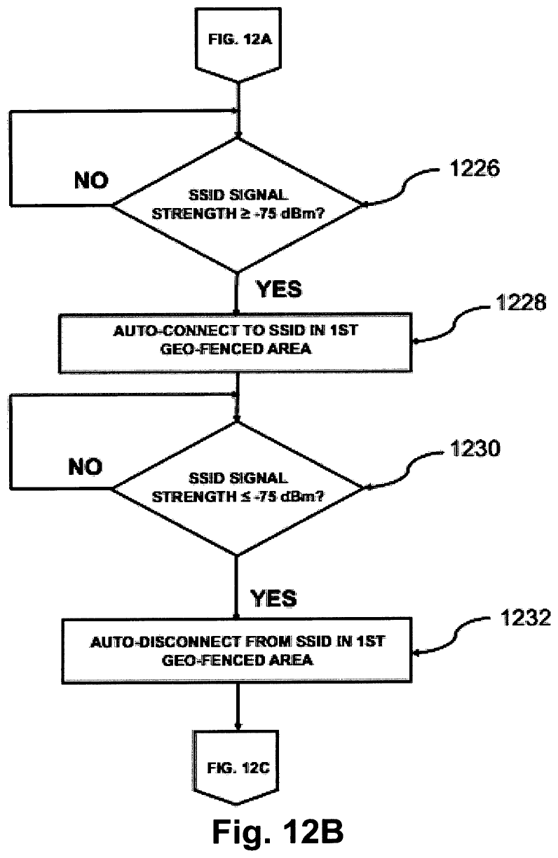

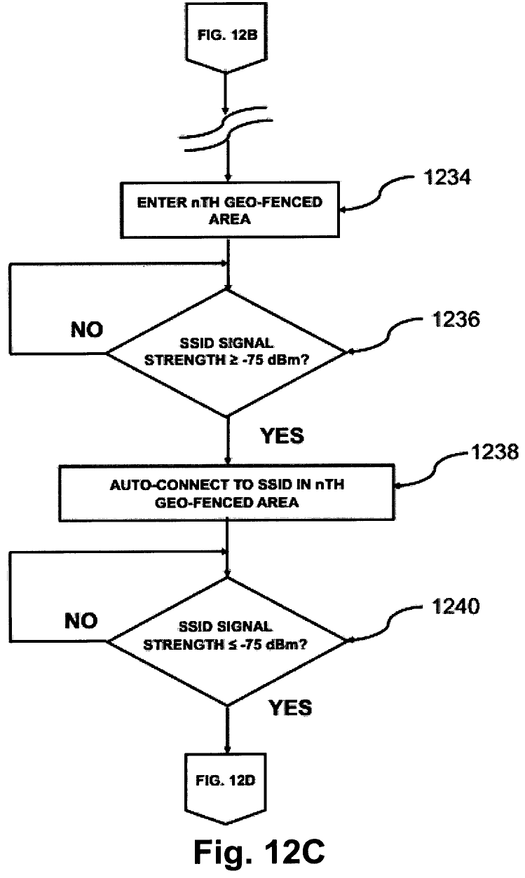

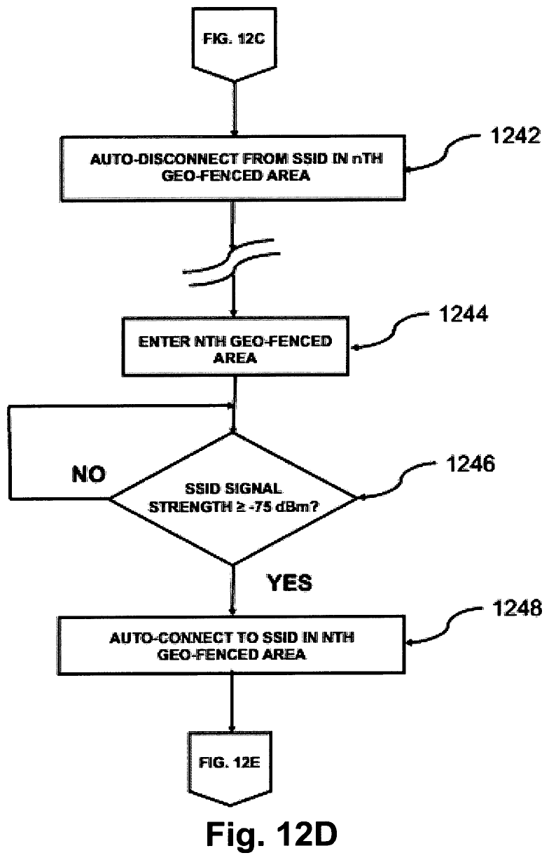

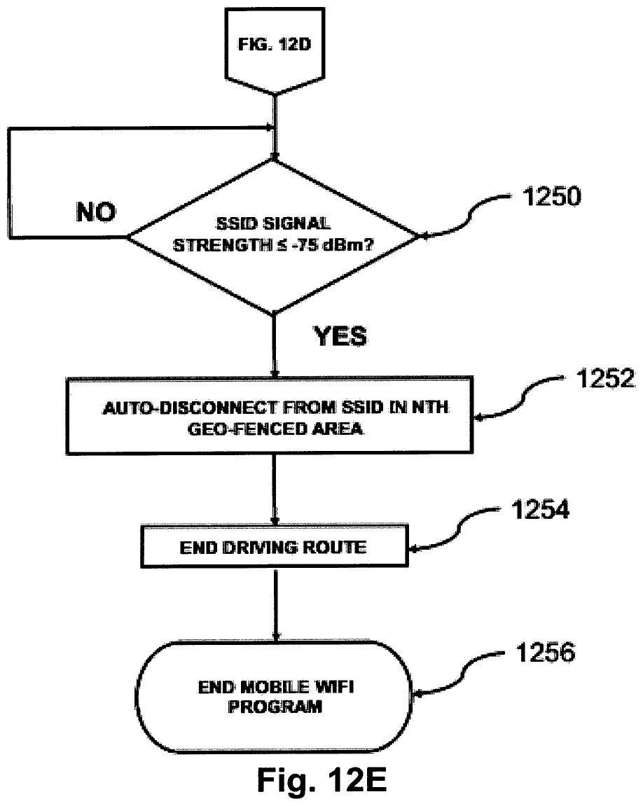

FIGS. 12, 12A 12B, 12C, 12D, and 12E is a flow chart illustrating operation of the preferred embodiment as a mobile Wi-Fi repeater.

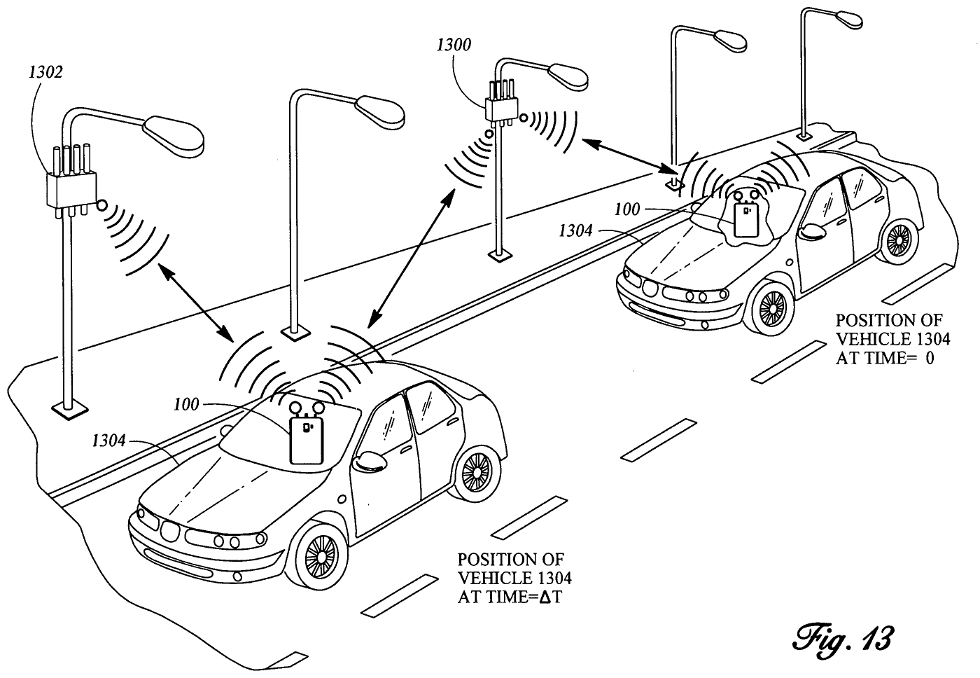

FIG. 13 illustrates a preferred embodiment located in a moving vehicle while accessing contiguous APs.

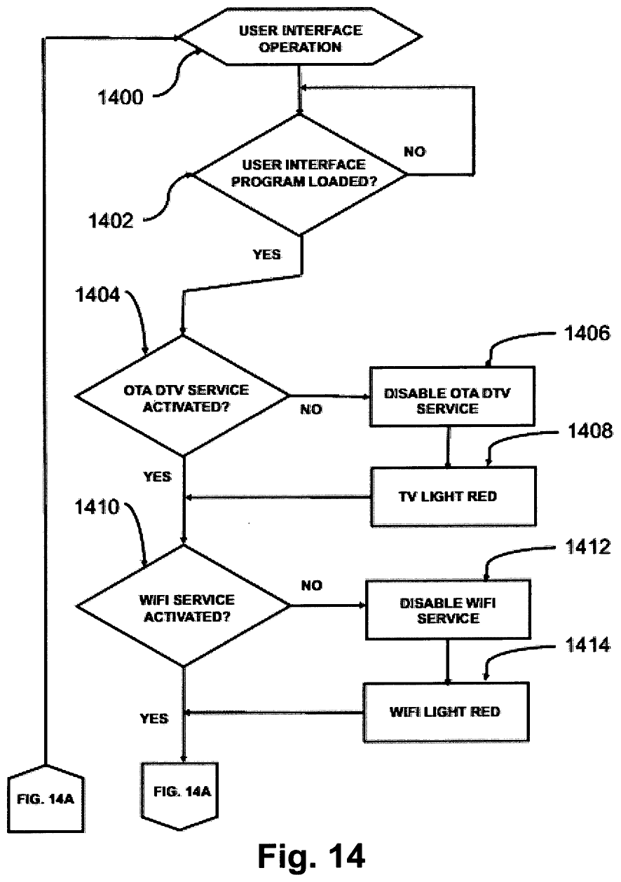

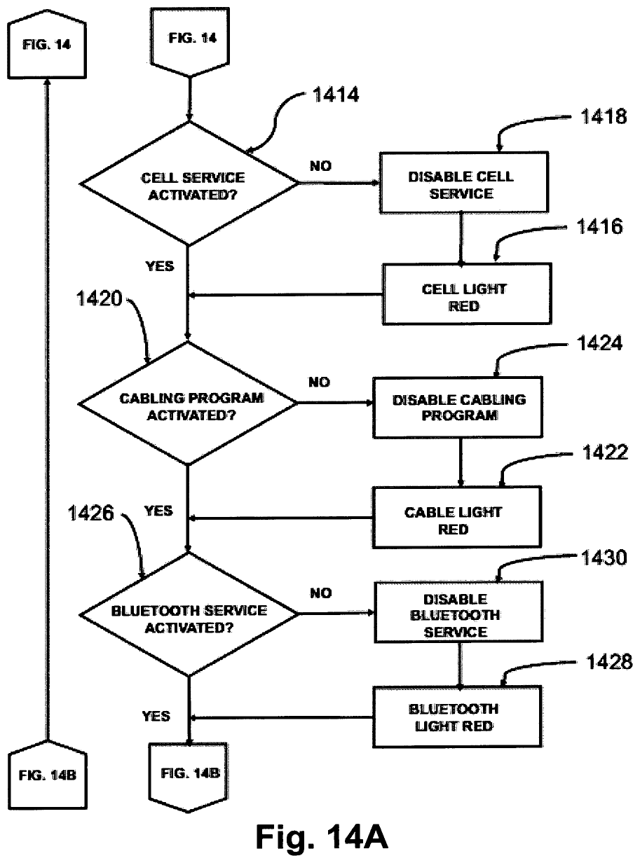

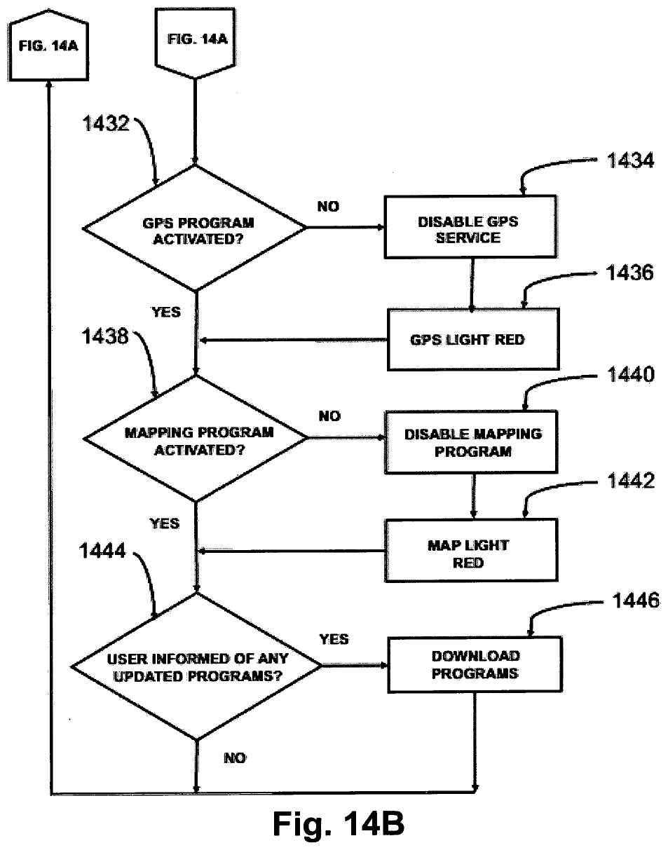

FIGS. 14, 14A, and 14B is a flow chart showing operation of the user interface.

### DETAILED DESCRIPTION OF THE INVENTION

### 1. Glossary of Terms Used in the Disclosure

“Access point,” “AP,” or wireless access point, “WAP,” is a networking hardware device that allows a Wi-Fi device to connect to a wired network.

“Backhaul” refers to the portion of a network that comprises the intermediate links between the core or backbone network and the edge networks. Smaller individual subnetworks are understood to be connected to the edge networks.

“Beacon frame” refers to one of the management frames in IEEE 802.11 based WLANs. A beacon frame is a periodic signal broadcasted by an AP or gateway/controller to inform Wi-Fi devices in its vicinity of its capabilities. Beacons are sent periodically at a time called the Target Beacon Transmission Time (TBTT). 1 TU=1024 microsecond. A typical TBTT=100 TU (100×1024 microseconds or 102.4 ms). Each beacon frame contains at least the SSID name; security capabilities; channel: specific frequency the SSID is operating on; channel width; list of all supported channels and corresponding channel settings; and beacon interval.

“Boot,” “boot up,” or “bootstrap,” means reading only that part of a computer's or smart device's programming from read-only memory (ROM), or firmware, sufficient to initialize the device. After the power is switched on, the boot program loads larger programs resident on the device's hard disk or main memory into random access memory accessible by the central processing unit for running those programs.

“Cabling” means transmitting information between devices via wire; such as, current and future versions of Ethernet, Multimedia over Coax Alliance (MoCA), HDMI, or USB standard, and its mini, micro, and full-duplex pin configurations.

“Central processing unit” or “CPU” means the electronic circuitry within a computing device that carries out the instructions of a program by performing the basic arithmetic, logic, controlling, and input/output (I/O) operations specified by the instructions.

“Computer program” or “program” means any sequence or human or machine cognizable steps which perform a function. The program may be written in virtually any programming language or environment that accomplishes the steps to be performed.

“Ethernet” refers to wired networking technology that allows devices connected by cables, typically optical fiber and twisted-pair wire, to communicate with one another. Ethernet products are compatible with the IEEE 802.3 standard.

“F Connector” or “F-type” refers to a coaxial RF connector used to connect a short whip antenna to capture OTA DTV signals.

“Gateway/Controller” or “Gateway,” means a device that routes packets from a WLAN to another network; wired or wireless WAN. Wireless gateways combine the functions of a wireless AP, a router, and security functions. They provide network address translation (NAT) functionality, so multiple user can use the internet with a single public IP. It also acts like a dynamic host configuration protocol (DHCP) to assign IPs automatically to devices connected to the network.

“High-Definition Multimedia Interface” or “HDMI” means a proprietary audio/video interface for transmitting uncompressed video data and compressed or uncompressed digital audio data from a HDMI-compliant source device, such as a display controller, to a compatible computer monitor, video projector, digital television, or digital audio device. The use of HDMI in this disclosure includes all of the current versions; i.e., Version 1.0, Version 1.1, Version 1.2, Version 1.3, Version 1.4, Version 2.0, and Version 2.1, and any versions that may be announced in the future.

“Hotspot” means a physical location where a person may obtain Internet access via a WLAN using a router connected to an internet service provider or a mobile hotspot device accessible through a cellular backhaul. A hotspot may be either a public or private. Public hotspots are accessible without the use of a password or passcode. Private hotspots are accessible only through a subscription and require a password or passcode for access.

“IEEE 802.3” means a collection of IEEE standards produced by the working group defining the physical layer and data link layer's media access control (MAC) of wired Ethernet. This is generally a local area network (LAN) technology with some wide area network (WAN) applications. Physical connections are made between nodes and/or infrastructure devices, such as hubs, switches, or routers, by various types of copper or fiber cable.

“IEEE 802.11” means a set of media access control (MAC) and physical layer (PHY) specifications created and maintained by the IEEE LAN/MAN Standards Committee (IEEE 802) for implementing WLAN computer communication in the 900 MHz, and 2.4, 3.6, 5, and 60 GHz frequency bands. The standard and amendments provide the basis for wireless network products using the Wi-Fi brand. In this disclosure, IEEE 802.11 refers to the following standards: 802.11a—devices operating in the 5 GHz band; 802.11b—devices operating in the 2.4 GHz band; 802.11g—devices operating in the 2.4 GHz band; 802.11n—devices operating in the 2.4 GHz and 5 GHz bands; and 802.11ac—devices operating in the 5 GHz band.

“IEEE 802.15” refers to a standards committee which specifies wireless personal area network (WPAN) standards. IEEE 802.15.1 defines physical layer (PHY) and Media Access Control (MAC) specification for wireless connectivity with fixed, portable and moving devices within or entering personal operating space; i.e., Bluetooth.

“Information” means characters, data, moving images, numbers, sounds, still images, or words, assembled and processed into a comprehensible and meaningful form, and electronically transmitted by wireless or wired technology in any one or more of the following forms; audio, alphanumeric character, grapheme, image, logogram, text, or video.

“Internet” means the global system of interconnected private, public, academic, business, and government computer networks linked by a broad array of electronic, wireless, wired, and optical networking technologies that use the Internet protocol suite; i.e., the Transmission Control Protocol (TCP) and the Internet Protocol (IP) to link devices worldwide.

“Internet of things” or “IoT” means the network of devices, vehicles, and home appliances that contain electronics, software, actuators, and connectivity which allows these things to connect, interact and exchange data. It involves extending Internet connectivity to any range of non-internet-enabled physical devices and everyday objects. Embedded with this technology, these devices can communicate and interact over the Internet and can be remotely monitored and controlled.

“Memory” means any type of integrated circuit or other storage device adapted for storing digital data including, without limitation, read only memory (ROM), programmable read-only memory (PROM), electrically erasable programmable read-only memory (EEPROM), dynamic random-access memory (DRAM), synchronous dynamic random-access memory (SDRAM), double data rate synchronous dynamic random-access memory (DDR2 SDRAM), extended data out/fast page mode memory (EDO/FPM), reduced-latency DRAM (RLDRAM), static random-access memory (SRAM), NAND/NOR “flash” memory, and pseudo-static random-access memory (PSRAM), and any other storage device that may be announced in the future.

“Microprocessor,” “Processor,” or “Digital Processor,” mean all types of digital processing devices including, without limitation, digital signal processors (DSPs), reduced instruction set computers (RISC), complex instruction set computers (CISC), microprocessors, field-programmable gate arrays (FPGA), programmable logic devices (PLD), reconfigurable computer fabrics (RCF), array processors, secure microprocessors, and application-specific integrated circuits (ASIC). Such digital processors may be contained on a single unitary integrated circuit die, or distributed across multiple components.

“Multiple systems operator” or “MSO” means a cable, satellite, or terrestrial network provider having infrastructure required to deliver services including programming and data over those mediums.

“Network” means any type of telecommunications or data network including, without limitation, hybrid fiber coax (HFC) networks, satellite networks, telco networks, and data networks, including metropolitan area networks (MAN), wireless area networks (WAN), local area networks (LAN), wireless local area networks (WLAN), internets, and intranets. Such networks or portions thereof may utilize any one or more different topologies, such as, bus, hybrid, loop, mesh, ring, or star, transmission media, wired/RF cable, RF wireless, millimeter wave, optical, or coaxial, and/or communications or networking protocols, including, but not limited to, synchronous optical networking (SONET), data over cable service interface specification (DOCSIS), IEEE 802.3, IEEE 802.11, asynchronous transfer mode (ATM), X.25 packet switched, and frame relay.

“Power over Ethernet” or “PoE” means any of several standard or ad-hoc systems which pass electric power along with data on twisted pair Ethernet cabling; allowing a single cable to provide both data connection and electric power to devices with an Ethernet connection.

“Programmed” means enabling a device to execute a computer program which contains any sequence of human or machine cognizable steps to perform a function. Such program may be rendered in virtually any programming language or environment including, for example, BASIC, C/C++, FORTRAN, COBOL, PASCAL, assembly language, markup languages, such as, HTML, SGML, XML, VoXML, and object-oriented environments such as the Common Object Request Broker Architecture (CORBA), Java™, including J2ME, and Java Beans.

“Router” means a networking device that forwards data packets between computer networks. Routers perform traffic directing functions on the Internet. Data sent through the internet, such as a web page or email, is in the form of data packets. A packet is typically forwarded from one router to another router through the networks that constitute an internetwork until it reaches its destination node.

“Server” means any computerized component, system or entity regardless of form which is adapted to provide data, files, applications, content, or other services to one or more other devices or entities on a computer network.

“Service Set Identifier” or “SSID” means a unique identification consisting of 32 characters used to name wireless networks. It identifies a group of wireless devices networked through a single AP. Data packets transmitted between these devices are identified by the SSID and is ignored by devices operating under a different SSID.

“SMA Connector” or “SubMiniature version A” means a connector with a 50Ω impedance designed to serve as a connection point for a Wi-Fi antenna.

“Smart device” is an electronic device, generally connected to other devices or networks via different wireless protocols such as Bluetooth, near field communication, Wi-Fi, 3G, 4G, 4G LTE, or 5G, that can operate interactively and autonomously. Smart devices, include, but are not limited to, smartphones, smart cars, smart thermostats, smart doorbells, smart locks, smart refrigerators, laptop computers, tablet computers, smartwatches, smart bands, smart key chains, and smart speakers.

“Storage” means computer hard drives, digital video recorder (DVR) device, memory, Redundant Array of Independent Disks (RAID) devices or arrays, optical media, such as CD-ROMs, Laserdiscs, or Blu-Ray, or any other devices or media capable of storing content or other information.

“Subscriber Identity Module” or “SIM Card,” refers to an integrated circuit that is intended to securely store the international mobile subscriber identity (IMSI) number and its related key, which are used to identify and authenticate subscribers on mobile telephone devices, such as mobile phones and computers. The term includes SIM cards of the current sizes; including, full-size SIM, mini-SIM, micro-SIM, and nano-SIM, and any other sizes or variants that may be introduced in the future.

“Universal serial bus” or “USB” means an industry standard that establishes specifications for cables, connectors and protocols for connection, communication and power supply between personal computers and their peripheral devices. It includes the current versions and pin connector arrangements; USB 1.0, USB 2.0, USB 2.0 Revised, USB 3.0, USB 3.1, and USB 3.2, and any of those in the future.

“Vehicle” means a machine that transports people or cargo. It includes: motor vehicles, such as motorcycles, cars, trucks, and buses; railed vehicles, such as trains; and watercraft, such as ships and boats.

“Wired Equivalent Privacy” or “WEP” means a security algorithm for IEEE 802.11 wireless networks. It is superseded by WPA, WPA2, and WPA3.

“Wi-Fi” means Wi-Fi®, a trademark of the Wi-Fi Alliance, a common term used to represent technology for the radio wireless local area networking of devices based on IEEE 802.11 standards, and any of its variants, including 802.11a, 802.11b, 802.11g, 802.11n, and 802.11ac.

“Wi-Fi Protected Setup,” or “WPS,” means a network security standard to create a secure wireless network. WPS works for wireless networks that use a password encrypted with the WPA, WPA2, or WPA3 security protocols.

“Wireless” means any wireless signal, data, communication, or other interface including without limitation Wi-Fi, Bluetooth, 3G (3GPP/3GPP2), 4G, 4G LTE, HSDPA/HSUPA, TDMA, CDMA, IS-95A, WCDMA, FHSS, DSSS, GSM, PAN/802.15, WiMAX (IEEE 802.16), IEEE 802.20, Zigbee®, Z-wave, narrowband/FDMA, OFDM, PCS/DCS, LTE/LTE-A, analog cellular, CDPD, satellite systems, millimeter wave or microwave systems, acoustic, and infrared IrDA.

“Wi-Fi Protected Access,” “WPA,”, “Wi-Fi Protected Access II,” “WPA2,” “Wi-Fi Protected Access 3,” and “WPA3,” are security protocols and security certification programs developed by the Wi-Fi Alliance to secure wireless computer networks. The WPA security protocols supersede WEP.

### 1. DETAILED DESCRIPTION OF THE PREFERRED EMBODIMENT OF THE DEVICE

Item 100 in FIG. 1 depicts an image of the preferred embodiment of the device disclosed here. FIG. 1 also shows Item 120, a fish-eye camera, and Item 122, a speaker and microphone combination. Retractable solar panel, Item 400, is shown in its retracted position inside Item 100.

In FIG. 1A depicts the left side of Item 100, Item 144. Item 144 contains various cable connection points. By way of example, Item 106 is an on-off power switch, Item 108 is a micro-USB port, Item 110 is a standard USB port, Item 112 is a slot for a SIM card, Item 114 is a HDMI connection point, Item 116 is an Ethernet connection port, and Item 118 is a low voltage power connection point. Item 102 are left and right SMA Connectors for dual Wi-Fi antennas and Item 104 is a F Connector for the attachment of an external OTA DTV antenna. FIG. 1A also shows the left side of retractable solar panel, 400.

FIG. 1B shows the right side of 100, Item 146. Item 146 contains a button, Item 124, to enable WPS, and series of status lights. The status lights indicate the following: Item 126 is a light showing power on or off; Item 128 shows the status of WPS enablement; Item 130 the status of the OTA DTV program; Item 132 the status of the Wi-Fi program; Item 134 the status of the cellular access program; Item 136 the status of the cable connection program; Item 138 the status of the Bluetooth program; Item 140 the status of the GPS position program; Item 144 the status of the Mapping program, and Item 148 shows that the User Interface program is loaded. FIG. 1B also shows the right side of retractable solar panel, 400.

FIG. 2 illustrates the four telecommunication infrastructures that Item 100 typically connects to while in use. Item 200 represents a GPS Satellite to provide 100 with location data. Item 206 depicts a transmission tower with OTA DTV antennae 202 broadcasting to 100 and cellular antennae 204 in 2-way communication with 100. Item 208 depicts a pole-mounted 2.4/5.0 GHz dual band Wi-Fi Antenna in 2-way communication with 100.

FIG. 3 depicts 100 in 2-way wireless communication with a series of user's IEEE 802.11 compatible devices. By way of example, Item 100 is shown communicating with an i-pad, Item 300, a laptop computer, Item 302, a network camera, Item 304, a smart phone, Item 306, and a Bluetooth, Item 308. It is also communicating with several IoT devices; such as, a smart television, Item 310, home refrigerator, Item 312, and a home thermostat, Item 314.

FIG. 4 shows 100 with the retractable solar panel, 400, extended. Items 402 and 404 are a Wi-Fi antennae and OTA DTV antenna, respectively. An Item 402 connects to each of Item 102 when antennae are required to enhance Wi-Fi reception and an Item 404 connects to Item 104 if required to improve OTA DTV reception. Item 420 is an external AC-to-DC power supply connected to 100 with low-voltage cable 422. Item 424 is a cable connecting 400 to 100.

FIG. 4 also shows some examples of various devices that may be attached to 100 via cable. Item 406 represents an external hard drive connected to 100 via a micro-USB cable, Item 416. Smart phone 306 is shown being charged by 100 via standard USB cable 418. SIM Card 410 is depicted as removed from SIM slot 112. Smart TV 310 is shown connected to 100 by HDMI cable, Item 412. Item 408 represents any number of Ethernet-compatible devices connected 100 via Ethernet cable, Item 414. Item 420 connects to power port, Item 118, to power 100.

FIG. 5 is a block diagram showing the hardware required to implement the functionality of the invention. Item 500 is the central processing unit (CPU). The device's multi-tasking demands require that CPU have at least 3 GHz clock speed, quad-core processor, and a 64-bit operating system, or equivalent. The input/output (I/O) control method and interface is shown as programmed I/O in FIG. 5, represented by Items 552, 554, and 556. Although programmed I/O is disclosed here and shown in FIG. 5, persons with skill in the art would understand that there are at least five general I/O control methods: programmed I/O; interrupt-drive I/O; memory-mapped I/O; direct memory access; and channel-attached I/O. Any one of these may be appropriate I/O control methods.

For OTA DTV reception, a system on a chip (SoC) for receiving and demodulating OTA DTV signals, Item 502, is connected to Item 500. Item 502 is a digital video broadcasting—second generation terrestrial (DVB-T2) tuner, demodulator, with integral dedicated CPU, and capable of receiving high-definition audio, video and graphics back-end for current and future DTV access. Item 502 is connected to Item 500 via a chipset-to-board connection, 510, through programmed I/O, represented by Item 552.

For OTA DTV, the individual DTV frequencies broadcast by transmission antenna 202 are received by antenna 404. The frequencies received by 502 range over the entire spectrum of bands represented by channels; 2 to 36, 38 to 53, 55 to 58, 62 to 64, and 67 to 69. The received channels are demodulated by chipset 502, communicated to 500 via chipset-to-board connection 510, through programmed I/O 552, processed by 500, and re-modulated. If a Wi-Fi compatible device is connected to 100, the re-modulated signal is communicated to chipset 504 via 530, through programmed I/O 552. The re-modulated OTA DTV signal is then wirelessly transmitted to a nearby smart device, say a smart television 310, via antennae 402. By way of example, if a smart television 310 is connected to 100 via a HDMI cable, 412, the OTA DTV signal is then transmitted to 310 by connection to HDMI port 114, through programmed I/O 554.

The disclosed device has camera capability through fish-eye camera 538 connected to high definition 720p camera SoC, 540. Item 540 is connected to 500, by chipset-to-board connection, 542, through programmed I/O 552.

For transceiving Wi-Fi frequency bands, Item 504, a 2.4/5 GHz 802.11ac with four multiple-in, multiple-out antennas (4×4 MIMO) SoC. is connected to 500. Item 504 supports IEEE 802.11a, 802.11b, 802.11g, 802.11n, and 802.11ac Wi-Fi compatible hardware. Item 504 is connected to Item 500 via a chipset-to-board connection, 530, through programmed I/O, 552. Antennae 402 are connected to Item 504. It is understood that Item 504 has antennae built into their chipsets and that 402 is attached to Item 100 by way of Item 504 only when required to improve reception.

Item 100 has sound receiving and production capability through microphone 548 and speaker 550, respectively. Items 548 and 550 are connected to a PC Sound Card, 544. Item 544 is connected to 500 by chipset-to-board connection 546 through programmed I/O, 552.

Transceiving cellular frequency bands is through a small cell SoC for cellular access for enterprise markets, Item 506. Item 506 has at least the following features; a 3G, 4G, and 4G/LTE small-cell transceiver; supports multiple networks and configurations, including, third generation time division—synchronous code division multiple access (3G TD-SCDMA) and wideband code division multiple access long term evolution (WCDMA LTE) in frequency division duplexing (FDD) and time division duplexing (TDD), and carrier WLAN with dedicated WLAN processor core. Item 506 is connected to 500 by chipset-to-board connection 532, through programmed I/O 552. Item 506 has internal antenna 512. Item 506 transceives 3G and 4G LTE cellular frequencies and band channels, specifically: for 3G, 850 MHz, 1,700 MHz, 1,900 MHz, and 2,100 MHz; for 4G LTE, 600 MHz on Band 71, 700 MHz on Bands 12, 13, 14, 17, and 29, 850 MHz on Bands 5 and 26, 1,700 MHz and 2,100 MHz on Bands 4 and 66, 1,900 MHz at 2 and 25, 2,300 MHz on Band 30, 2,600 MHz on Band 41, 3,600 MHz on Band 48, and 5,200 MHz on Band 46.

Terrestrial position of Item 100 is provided by a global navigation satellite system (GNSS) receiver with integrated sensor hub, 508. Item 508 supports GNSS frequencies L1 and L5. Item 508 must be capable of simultaneously receiving at least the following signals: L1 C/A, L5 and L1 C. Item 508 is connected to Item 500 via chipset-to-board connection 534 through programmed I/O 556. Antenna 514 is internal to 508. Positional accuracy is expected to be within +/−1 meter of actual position.

Item 100 status lights, represented by 524 in FIG. 5, are outputted from 500 via hardwire connection 536 through programmed I/O 556.

Item 526 represents the read only memory (ROM) required to bootstrap CPU 500 when 100 is first powered up. Item 526 communicates with the CPU via 8-bit word size represented by Item 528. Item 516 represents 8 GB of double data rate type three (DDR3) synchronous dynamic random-access memory (SDRAM). This is sufficient random access memory to operate the device. The 8 GB DDR3 memory communicates with the CPU by 64-bit word size, represented by Item 518. Item 520 is a 500 GB solid state non-volatile memory chipset. This is sufficient memory to store the administrative programs, downloaded applications, and databases, such as the AP maps, and GPS coordinates versus zip code library, required to operate the device in stationary or mobile mode. Item 520 is connected to Item 500 by a Serial AT Attachment (SATA) Version 3.0, Item 522, or greater connection with a data transfer rate of at least 6.0 Gbit/s, or equivalent.

Item 500 is connected through programmed I/O, Item 554, to the following input/output cable interfaces: micro-USB port, Item 108; USB port, Item 110; HDMI port, Item 114; and Ethernet port, Item 116. Item 500 is further connected to a SIM Card slot, Item 112, through 554. The power connection port, Item 118, is connected to 500 through an internal battery, Item 558. Power to 500 is provided through the internal battery, 558, via solar power 400, receptacle power 420, power over Ethernet through port 116, or by power over USB through port 110.

FIG. 6 shows Item 100 in stationary use on a moored boat, 600, FIG. 6A in a parked recreational vehicle, 630, and FIG. 6B in a remote area in a tent, 652, and in an apartment in complex 654.

FIG. 6 shows Item 100 in boat 600 receiving OTA DTV signal, 622, broadcasted from antenna 202, and cellular signal, 620, from antenna 204 mounted on transmission tower 206. The OTA DTV signal is shown as received by 100 in a 1-way transmission by 624. Item 100 is in 2-way communication with cellular signal 620, as shown by 616. Item 100 is also in 2-way wi-fi communication with in-range AP, 612, mounted on a pole at the pier, and AP, 608, mounted on nearby building 626. For the pole-mounted AP, 612, the 2-way wi-fi connection is shown as 614 and 618, and for the building-mounted AP, 608, as 610 and 606. Item 100 may also be in 2-way communication with hotspot 602 emanating from a router located in residence 628. This is represented by a 2-way connection, 602 and 604. Those with skill in the art would understand that among the wi-fi connections depicted as 602 and 604, 614 and 618, and 610 and 606, only one of the three is required for Item 100 to function as disclosed and claimed.

FIG. 6A shows Item 100 in a parked recreational vehicle 630. Here, Item 100 is receiving OTA DTV signal, 622, broadcasted from antenna 202, and cellular signal, 620, from antenna 204 mounted on transmission tower 206. The OTA DTV signal is shown as received by 100 in a 1-way transmission by 624. Item 100 is in 2-way communication with cellular signal 620, as shown by 616. Item 100 is in 2-way wi-fi communication with in-range AP, 632, mounted on a telephone pole, and AP, 640, mounted on the park lodge, 638. For the telephone pole-mounted AP, 632, the 2-way wi-fi connection is shown as 634 and 644, and for the lodge-mounted AP, 640, as 642 and 646. Item 100 may also be in 2-way communication with hotspot 636 emanating from a router located in an adjacent recreational vehicle 650. This is represented by a 2-way connection, 636 and 648. Those with skill in the art would understand that among the wi-fi connections depicted as 634 and 644, 642 and 646, and 636 and 648, only one of the three is required for Item 100 to function as disclosed and claimed.

FIG. 6A shows Item 100 in tent, 652, in a remote area, and in an apartment in building 654. In tent, 652, Item 100 is receiving OTA DTV signal, 622, broadcasted from antenna 202, and cellular signal, 620, from antenna 204. The OTA DTV signal is shown as received by 100 in a 1-way transmission by 624. Item 100 is in 2-way communication with cellular signal 620, as shown by 616. Persons with skill in the art understand that OTA DTV signals have a range of about 30 miles and that cellular signals about 5 miles from a base transmission tower permitting 100 to function as disclosed and claimed in remote areas. Those with skill in the art would also understand that in a remote area as depicted by 652, that wi-fi connections would not generally be available due to their limited range. For the apartment building, Item 100 is shown in 2-way communication with hotspot 656 emanating from a router located in an adjacent apartment. This is represented by a 2-way connection, 656 and 658.

FIG. 7 shows the device in mobile mapping mode. Device 100 is in vehicle 702 driving past AP or gateway/controller 700. Vehicle 702 is shown approaching 700 from the right. As 702 is moving, Item 508 within 100 continuously monitors its location as decimal degrees of latitude and longitude (LAT/LONG). On about 102.4 ms intervals, gateway/controller 700 transmits its beacon frame to announce its presence. The beacon frame contains the following data: SSID name; BSSID; security capabilities; channel; channel width; list of all supported channels and corresponding channel settings; and beacon interval.

The beacon frame does not transmit its geospatial location; necessary for mapping the AP or gateway/controller. To provide this important data, Item 100 is programmed to determine the geospatial location of a mapped AP. Referring to the automobile at the right of FIG. 7, at Time=0 when 100 in vehicle 702 receives the beacon frame from 700, it marks the time the signal is received and compares it to beacon frame's time stamp. Item 508 within 100 records the location of 100 as decimal decrees of LAT/LONG. The difference between the time the signal is received and the beacon frame's time stamp is the transit time, depicted as T2 in FIG. 7. The distance D2 shown in FIG. 7 is T2 divided the speed of light in air (C); 299,792,458 m/s. For 2.4 GHz Wi-Fi, the beacon frame can be received by an Item 100 from an AP 700 when 100 is about 100 m from 700. At this distance, the transit time T2 is expected to be about 3 μs; well within the resolution of the clock in 100. For 5 GHz Wi-Fi, the beacon frame can be received from AP 700 when 100 is about 30-50 m from 700. Transit time from 700 is expected to be 1 to 1.5 μs; still within the device's clock's resolution.

By way of example, if vehicle 702 is traveling 50 MPH, or about 22.4 m/s, it remains within the 2.4 GHz 100 m radius range of AP 700 for about 10 seconds and within the 5 GHz 50-75 m radius range for about 5 seconds. Beacon frames are typically sent at about 100 ms intervals. At this beacon frame interval and speed of vehicle 702, 702 can receive about 100 beacon frames at 2.4 GHz and 50-75 at 5 GHz. As shown at the left of FIG. 7, at Time=0+AT, Item 100 receives a beacon frame. This transit time is represented by T3 in FIG. 7. Distance D3 from AP 700 to 100 at Time=0+AT is T3 divided by C. Item 508 again records the new location of 100 as decimal degrees of LAT/LONG.

Referring to FIG. 7 and using data captured at 2.4 GHz, the decimal LAT/LONG data for the position of 702 captured at Time=0 is represented by (X1, Y1) and that at Time=0+AT by (X2, Y2). The unknown LAT/LONG of 700 is represented by (X3, Y3). Item 100 is programmed to calculate the straight-line distance, D1 in FIG. 7, traveled by vehicle 702, from the LAT/LONG data captured by 508 at Time=0 and Time=0+AT by the equation:

D1=((X2−X1)²+(Y2−Y1)²)^{1/2}. EQ. 1

D1, D2, and D3 form a triangle with sides of known length D1, D2, and D3 and known LAT/LONG points (X1, Y1) and (X2, Y2). Item 100 is programmed to determine the LAT/LONG of Item 700 using the following equations:

COS α=(D1²+D2²−D3²)/(2×D1×D2) where α is Angle D1 D2 shown in FIG. 7. EQ. 2

SIN α=+/−(1−COS α²)^{1/2}. EQ. 3

X3=X1+(D2/D1)×(COS α×(X2−X1)−SIN α×(Y2−Y1)). EQ. 4

Y3=Y1+(D2/D1)×(SIN α×(X2−X1)+COS αx·(Y2−Y1)). EQ. 5

D1 and D2 are shown in FIG. 7.

The LAT/LONG of 700 is saved with the corresponding data captured from the AP and its beacon frame for each SSID: SSID name; BSSID; security capability; channel; channel width; The data group for each SSID is called an AP MAP.

Although only two points of LAT/LONG data are needed to triangulate the position of the AP, Item 100 collects data as it passes by the AP under study for SSIDs transmitted at both 2.4 GHZ and 5 GHz. This data is used to create the locations on the route and the geo-fence at which the signal strength broadcasted by AP 700 exceeds −75 dBm for 2.4 GHz and 5 GHz.

Referring to FIG. 7, for a directional antenna pointing towards the route, the geo-fence for both 2.4 GHz, Item 704, and 5 GHz, Item 706, Wi-Fi is a semi-circle with center at LAT/LONG (X3, Y3) previously determined by triangulation. The straight sides of the semi-circles, one for 2.4 GHz and the other for 5 GHz, passing through (X3, Y3) are parallel to D1. The radius of the semi-circle is the distance from (X3, Y3) to the points created by projecting the line extending from signal strength −75 dBm on the route to where it intersects perpendicularly with the line crossing through (X3, Y3); shown in FIGS. 7 as (X4, Y4) and (X5, Y5) for 2.4 GHz Wi-Fi and (X6, Y6) and (X7, Y7) for 5 GHz.

For a semi-circle centered at (X3, Y3) with radius R measured as the distance from (X3, Y3) to (X4, Y4) or (X3, Y3) to (X5, Y5), the perimeter of the 2.4 GHz geo-fence is calculated as follows:

(X−X3)²+(Y−Y3)²=R². EQ. 6

R=((X4−X3)²+(Y4−Y3)²)^{1/2} or R=((X5−X3)²+(Y5−Y3)²)^{1/2} EQ. 7

The equations are the same for the 5 GHz geo-fence with the substitution of (X6, Y6) and (X7, Y7) for (X4, Y4) and (X5, Y5), respectively.

The AP MAP for AP 700 and 2.4 GHz and 5 GHz geo-fence equations are uploaded to the AP Database. The program which manages the AP Database first confirms if AP 700 has been previously mapped. If not, the AP Database assigns a unique sequential number to AP 700 in the AP Database, with additional sequential numbers to represent each SSID supported by the AP. The process is repeated as more APs are mapped. The accumulated data are downloaded to all subscribing devices.

### 2. Detailed Description of the Method of Using the Preferred Embodiment of the Device

Device 100 is powered up according to the steps in FIGS. 8 to 8B. Throughout FIGS. 8 to 8B, the reference numerals refer to steps. The starting point for power up is shown as step 800 in FIG. 8. The program continually monitors the position of the on-off power switch, 106; shown as 802 in FIG. 8. When 106 is selected on, the program first checks the power level, 804. If the power level is low, power status light 126 is illuminated yellow, step 806. This indicates to user to determine if external power is available, 808. If so, referring to 810, user plugs the AC plug of 420 into a nominal 115-volt receptacle and the DC plug into connection 118 on 100. If external power source is not available, but 100 may be exposed to a light source, step 812, the user extends 400, step 814, and points it towards the source. If a source of light is not available and batteries are at hand, step 816, user replaces batteries 424, step 818. Referring to FIG. 8A, once power level is within an acceptable level, power light 126 blinks green, step 822. If there are no alternative sources of power, power light 126 is steady red, step 820 and power up is stopped by returning to step 802.

Once power level is within acceptable limit, Item 100 is programmed to boot up, step 824, by loading the Boot Program resident on 526. After boot up, the User Interface Program, Item 860, WPS Program, Item 844, OTA DTV Program, Item 846, WIFI Program, Item 848, CELL Program, Item 850, CABLING Program, Item 852, BLUETOOTH Program, Item 854, GPS Program, Item 856, and MAPPING Program, Item 858, resident on 516 are loaded via connection 518, step 826. The program waits at step 828 until boot up and programs are loaded.

As shown in FIG. 8B, after programs are loaded, power light 126, TV light 130, WIFI light 132, CELL light 134, CABLE light 136, BLUETOOTH light 138, GPS light 140, MAP light 142, and User light 148, are steady green, step 830. The position of WPS button 124 is monitored, step 834. If the WPS button is off, WPS light 128 is steady yellow, step 832. Once the WPS button is on, WPS light is steady green and WPS is enabled, step 836.

In step 838, the Boot Program sends a request to the User Interface Program to check which of the previously loaded applications have been either purchased or subscribed to by the user. Referring to FIG. 8C, in step 840 the Boot Program queries for applications not purchased or subscribed to. For each of these applications, the status light is changed to steady red, step 842. It is understood that for any deactivated application, its status light will remain steady red until the application is activated and control of the status light is returned to that program.

While 100 is in use, a user may purchase or subscribe to an application by the User Interface Program. In this instance, the Boot Program monitors for activated applications, step 844. Referring to FIG. 8D, if applications are activated, the status light for that application changes to steady green, step 846, indicating to the user the application is now activated. Further status light control is transferred to the application program, step 848. As long as the Power Switch 106 is on and 100 is powered up, the Boot Program continually monitors for activation or deactivation of applications, steps 840, 842, 844, 846, and 848, and accordingly updates the status lights. The position of Power Switch 106 is continually monitored, step 850. When the power switch is selected off, 100 is powered off, step 852, and the program returns to step 802.

FIGS. 14 to 14B is a flow chart showing operation of the User Interface Program, beginning with step 1400. Referring to FIG. 14, the program waits at step 1402 until the User Interface Program is loaded. Once loaded, the program queries whether or not the user has purchased or subscribed to the OTA DTV Program, step 1404. If not, the User Interface Program disables OTA DTV service and changes the TV light 130 to steady red, steps 1406 and 1408. The same is done for the Wi-Fi Program, steps 1410, 1412, and 1414. In FIG. 14A, the same query is done for the Cellular Service Program, steps 1414, 1416, and 1418; the same for the Cabling Program which controls I/O for the cable-connected device, steps 1420, 1422, and 1424; and the same for the Bluetooth Program, steps 1426, 1428, and 1430. Referring to FIG. 14B, the User Interface Program confirms if the user has purchased or subscribed to the GPS Program and, if not, disables that program and changes the GPS light 140 to steady red, steps 1432, 1434, and 1436. The same is done for the Mapping Program, steps 1438, 1440, and 1442. The User Interface Program then queries whether or not the user has been informed of any updated programs, step 1444. If so, the programs are downloaded, step 1446. If no new programs are available, the User Interface Program returns to step 1400.

FIGS. 9 to 9C is a flow chart showing how the OTA DTV feature is programmed. OTA DTV operation begins at step 900 in FIG. 9. After the OTA DTV program (DTV Program) is loaded, TV light 130 is steady green. The DTV Program scans the signal strengths of available OTA DTV channels, step 902. The DTV Program retrieves the stored preprogrammed signal strength and signal quality parameters, step 904, stored in memory in Item 520. For example, the data includes the Noise Figure (NF) in dB, the Minimum Signal to Noise Ratio (S/N Ratio) in dB, the Receiver Noise Bandwidth (Hz) and the average temperature of the location where the device is located, step 904. The DTV Program calculates the Minimum OTA DTV Signal Strength in dBm, step 906, as follows:

Minimum OTA DTV Signal (dBm)=(k×T×B)+NF+SNR Minimum
Minimum dBm=Minimum signal level required
k=Boltzmann's Constant=1.380622×10⁻²³ Watt-sec/K

### T=Temperature in K.

### B=Receiver Noise Bandwidth in Hertz (Hz)

### NF=Noise Figure

### SNR Minimum=Minimum Signal-to-Noise Ratio

k× T×B=1.380622×10⁻²³ Watt-sec/K×300 K×6×10⁶/sec=2.40×10⁻¹¹ mW=−106 dBm
Minimum OTA DTV Signal=−106 dBm+10 dB+30 dB=−66 dBm

Moving to FIG. 9A, the DTV Program determines if any OTA DTV signals have a signal strength greater than the minimum dBm, step 908, calculated in step 906, here by way of example, −66 dBm. If channels are available, TV light 130 remains steady green, step 910. If not, TV light is steady yellow, step 912 and the user first relocates 100, to say a window, steps 914 and 916. The DTV Program then determines a new set of OTA DTV signals and if any are greater than the minimum dBm, step 908, the TV light returns to steady green, step 910. If not, the user attaches TV antenna 404, to connection 104 on 100, steps 918 and 920. The DTV Program then determines a new set of OTA DTV signals and if any are greater than the minimum dBm, step 908, the TV light is steady green, step 910.

In FIG. 9B, if there are no OTA DTV with signal strength greater than the minimum dBm, the TV light is steady red, step 922, and the program returns to step 900. If channels are available, the OTA DTV channels are demodulated in 500, step 924, and remodulated in 504. The DTV Program checks for Wi-Fi connected devices, steps 926 and 928. If Wi-Fi devices are connected to 100, the DTV Program remodulates the demodulated channels to transmit to any Wi-Fi device compatible with IEEE 802.11 a, b, g, n, or ac, step 930. The transmitted signal contains the channel number, program guide, audio, and video for each channel, step 932. If Wi-Fi compatible devices are not connected, the DTV Program checks for devices connected by cable, steps 934 and 936. If yes, the DTV Program remodulates the demodulated channels to transmit to any device connected to 100 via Ethernet, HDMI, or USB, step 938. The transmitted signal contains the channel number, program guide, audio, and video for each channel, step 940.

If no Wi-Fi compatible or cabled device is connected to 100, the DTV Program returns to step 902.

FIGS. 10 to 10F. is a flow chart showing the steps in using 100 as a stationary Wi-Fi repeater. Stationary Wi-Fi operation begins at 1000 on FIG. 10. The Stationary Wi-Fi program (Wi-Fi Program) accesses preprogrammed signal strength and signal quality parameters saved in memory on 520. By way of example, the preprogrammed minimum signal strength is −70 dBm and the minimum SNR is 30 dB, step 1002. The Wi-Fi Program checks for SSIDs meeting the minimum signal strength and SNR parameters, steps 1004 and 1006. If at least one SSID exceeds the minimum signal parameters, the WIFI light 132 is steady green, step 1008. If no SSIDs meet the minimum signal parameters, the WIFI light is steady yellow, step 1010, and the program checks if device 100 has been relocated closer to the AP or antennae 402 attached to 102, steps 1012, 1014, 1016, and 1018. After relocation of 100 or antennae are attached, or both, and there is still no SSID meeting the required signal strength and quality parameters, WIFI light is steady red, step 1054. The Wi-Fi Program then returns to step 1004.

Looking at FIG. 10B and by way of example, if at least one SSID is meets the minimum signal strength and quality parameters, the Wi-Fi Program transmits the data shown in step 1020 to any device connected wirelessly or by wire to 100.

Referring to FIG. 10C, the connected Wi-Fi compatible devices display the data each is programmed to display, steps 1024 and 1026. For example, one such connected device might display what is shown as step 1026 in FIG. 10C.

The Wi-Fi Program next determines if Auto SSID Select is enabled, step 1028. If so, 100 selects the SSID by a preprogrammed protocol, step 1032. If Auto SSID Select is not enabled, the user selects the SSID manually from those displayed on the connected device, step 1030.

Following FIG. 10D and by way of example, if Auto SSID Select is enabled, the SSID data displayed on the user's device connected to 100 is shown in step 1034. In this instance, the user's device, 300 or 302, has auto-selected Hotspot1.

If Auto SSID Select is not selected, the user determines if he or she has the security credentials to select one of the secured SSIDs, step 1036. If the user has the credentials, he or she enters them, step 1038, and the user's device, 300 or 302, displays the selected SSID, step 1040. For example, the user's device might display the information shown in step 1042:

Looking to FIG. 10E, if the user does not have credentials to select a secure SSID, the user selects an open SSID, steps 1044, and 100 displays the selected SSID, step 1048, on user's device, 300 or 302.

In all cases, the Wi-Fi Program continually checks if the connection between user's device and 100 is intact, step 1050. If yes, 100 remains connected to available hotspots until the user disconnects, step 1052, or if the Wi-Fi connection is lost for other reasons, the WIFI light is steady red, 1054, and the Wi-Fi Program returns to step 1004.

FIGS. 11 to 11H is a flow chart depicting the steps for mapping APs by Item 100 via the AP mapping program (Map Program). AP mapping begins at step 1100 on FIG. 11. AP Mapping is undertaken by enabling the GPS location function, step 1102, the Mapping Program, step 1104, selecting a route, step 1106, and driving the selected route, step 1108. The Map Program scans for beacon frames broadcast by any APs within range of 100, step 1110. If a beacon frame is detected, the user enters whether or not the AP is visible, step 1112. If the AP is not visible, such as a router located inside a building, the Map Program returns to step 1108. If the AP is visible, the Map Program asks the user if the AP has already been mapped, step 1114. If yes, mapping continues, but the previously assigned unique AP identifier is assigned an extender to identify this as a subsequent mapping, step 1116. If the AP has not been previously mapped, the Map Program assigns it a unique alphanumeric designation, step 1118.

The AP beacon frame contains a clock signal. The device clock and AP clock are synchronized when the beacon frame is received, step 1120. After the initial synchronization, the device is locked against further synchronization, step 1122, until the device clock is unlocked, step 1180. In FIG. 11B, data acquisition begins at step 1124, by 100 acquiring the first data set, step 1126. At the moment the first data set is obtained from the beacon frame, the GPS location feature identifies the LAT/LONG of the vehicle in which 100 is located, step 1128. 100 also records the elapsed time to receive the first set data set, step 1130. The elapsed time is the difference between the time of the beacon frame and the time the signal is received by the clock in 100. The data acquired from the beacon frame is shown in step 1132. The first data set collected by 100 contains the SSIDs broadcast by the AP, the frequency, channel number, signal strength, IEEE 802.11 physical layer, and security, as shown in step 1132.

The Map Program assigns a number 1 followed by −1 to N to each SSID in the first data set, where N represents the total number of SSIDs broadcast by the AP under study, step 1134. If a beacon frame is still received, step 1136, mapping continues, if not, mapping is terminated, step 1190.

Referring to FIG. 11C, data sets are acquired as vehicle 702 passes by the AP. As data is collected while passing the AP, the Map Program assigns a number n followed by −1 to N to each SSID as each data set is collected. As expected the signal strength will increase as the AP is approached, and then decrease as the vehicle passes by. The point of maximum strength is designated as the cth data set, step 1138, shown below. Data acquisition continues as previously described, steps 1140, 1142, 1144, and 1146. By way of example, the cth data may appear as shown in step 1144.

If beacon frames are still received, step 1148, the Map Program continues acquiring data until the Nth data set is acquired, steps 1150, 1152, 1154, 1156, and 1158 in FIG. 11D. The data collected as the Nth data set may be that as shown in step 1156.

As depicted in FIG. 11E, if enough data sets are acquired to map the AP and provide the necessary data for seamless handoff, step 1160, calculation of the AP location is undertaken, step 1162. The Map Program selects two of the N data sets for triangulation; with one being the cth−nth data set and the other being the cth+mth data set, steps 1164, 1166, and 1168. The Map Program first calculates the straight-line distance, D1, between the vehicle's LAT/LONG at the acquisition of the cth−nth data set and the cth+mth data set, step 1170.

Referring to FIG. 11F, the Map Program then calculates the straight-line distance between the AP and the vehicle's LAT/LONG at the time of acquisition of the cth−nth data set, D2, and the cth+mth data set, D3. Using trigonometric functions, the Map Program calculates the LAT/LONG of the AP, step 1174; where X3 is the decimal LAT and Y3 is the decimal LONG of the AP. The LAT/LONG of the AP is saved in 100 and uploaded to a central database for later download to all other like 100 devices.

In FIG. 11G, the mapping data for the subject AP is saved, which includes, the AP's unique alphanumeric identifier, including extender, the AP's LAT/LONG, route from which data was acquired, and other data required for seamless handoff in the future, shown in step 1178. The signal strengths are equal for all 2.4 GHz SSIDs received by 100 and are equal for all 5 GHz SSIDs. However, received signal strengths are typically lower for 5 GHz versus 2.4 GHz due to more free space path loss at the higher frequency.

Once data collection is complete, device 100 clock is unlocked permitting it to be synchronized with APs to be mapped in the future, step 1180. The Map Program fits the collected signal strength data to best fit curves for 2.4 GHz and 5 GHz, step 1182. The Map Program then calculates a geo-fence bounded at signal strength at −75 dBm for 2.4 GHz and 5 GHz, step 1184. Although the periphery of the geo-fence is set by the AP's broadcasted signal strength, the area bounded by the geo-fence depends on whether the antenna is omni-directional or directional. If the AP's antenna is omni-directional, the geo-fenced area will approximate a circle, and if directional, a half-circle, both centered at the AP. For example, FIG. 7 depicts a half-circle geo-fence around AP 700 for both 2.4 GHz and 5 GHz Wi-Fi.

If mapping is complete, step 1186, the Map Program ends, step 1190. If another AP is to be mapped along the same route, scanning continues, step 1188, and the Map Program returns to step 1100.

FIGS. 12 to 12E is a flow chart showing how Item 100 can be used as a mobile Wi-Fi repeater. The reference numerals refer to steps in the process of implementing mobile Wi-Fi. Referring to FIGS. 12 and 12A, the start of mobile Wi-Fi is shown as step 1200. The user first determines if the route for which mobile Wi-Fi is to be selected by the user or by a program resident in 100, step 1202. If the route is the selected automatically, the user enters the starting and ending addresses, step 1212. Based on the mapping of available APs, the user's security credentials, or the availability of open Wi-Fi access, the program selects a route for uninterrupted mobile Wi-Fi, step 1214. If no route is found for uninterrupted Wi-Fi, the program defaults to a user selected route, steps 1216 and 1206.

If programmed route selection is not available or no route can be automatically selected, the user selects the route, step 1206. The user then confirms that the selected route has been mapped, step 1208, GPS enabled on Item 100, step 1210, security credentials are confirmed along the route, step 1218, and that auto-handoff is enabled, step 1220. If any of steps 1208, 1210, 1218, and 1220 are not confirmed, loss of service will be expected along the route, step 1204.

Once the confirmations in steps 1208, 1210, 1218, and 1220 are made or the route has been automatically selected, the user begins driving the route, step 1222. He or she enters the first geo-fenced area previously mapped, step 1224. Referring to FIG. 12B, while on mobile Wi-Fi mode, Item 100 is monitoring for beacon frames and SSID signal strength within the first geo-fenced area. Once Item 100 determines the received signal strength is greater than or equal to −75 dBm, Item 100 auto-connects to that SSID, steps 1226 and 1228. As the user passes by the AP, Item 100 monitors the signal strength of the Wi-Fi signal, step 1230.

Looking to FIG. 12B, once the signal strength drops below −75 dBm, Item 100 auto-disconnects from the SSID in the first geo-fenced area, step 1232. Item 100 then immediately enters the next geo-fenced area, represented in FIG. 12C as the nth geo-fenced area, step 1234. On entering the nth geo-fenced area, Item 100 monitors for beacon frames and SSID signal strength within this area. Once Item 100 determines the received signal strength is greater than or equal to −75 dBm, Item 100 auto-connects to the SSID in this area, steps 1236 and 1238. As the user passes by the AP in the nth area, Item 100 monitors the signal strength of the Wi-Fi signal, step 1240.

Looking to FIG. 12D, once the signal strength drops below −75 dBm, Item 100 auto-disconnects from the SSID in the nth geo-fenced area, step 1242. Item 100 then immediately enters the next geo-fenced area, represented in FIG. 12D as the Nth geo-fenced area, step 1244. On entering the Nth geo-fenced area, Item 100 monitors for beacon frames and SSID signal strength within this area. Once Item 100 determines the received signal strength is greater than or equal to −75 dBm, Item 100 auto-connects to the SSID in this area, steps 1246 and 1248. Looking to FIG. 12E, as the user passes by the AP in the Nth area, Item 100 monitors the signal strength of the Wi-Fi signal, step 1250. Once the signal strength drops below −75 dBm, Item 100 auto-disconnects from the SSID in the Nth geo-fenced area, step 1252. The Nth geo-fenced area here represents the end of the selected route, step 1254, and the mobile Wi-Fi program ends, step 1256.

FIG. 13 shows mobile Wi-Fi in use. Items 1300 and 1302 represent two contiguous APs, broadcasting Wi-Fi signals at 2.4 GHz and 5 GHz. Vehicle 1304 has device 100 mounted inside. Vehicle 1304 is at the positions shown to the right of FIG. 13 at Time=0. Once Vehicle 1304 enters the geo-fenced area embracing AP 1300, Item 100 detects a broadcasted SSID and connects to it. As Vehicle 1304 passes by AP 1300, it continually monitors the strength of the Wi-Fi signal. Once the signal strength drops below −75 dBm, Vehicle 1304 disconnects from AP 1300 and connects to AP 1302 at Time=ΔT. The automatic connection and disconnection among contiguous APs continues until the route has been completed or there is a break in Wi-Fi service.

Persons of skill in the art of designing and programming cellular and Wi-Fi devices would understand that the device and method of using the device described in the preferred embodiment can vary and still remain within the invention herein described. Variations obvious to those persons skilled in the art are included in the invention.

For example, Item 100 could have more or less features and programs that are described here for the preferred embodiment. The arrangement of features and mode of programming can vary according to methods known to persons of skill in the art and still be included in the invention described herein.

This written description uses examples to disclose the invention, including the preferred embodiment, and also to enable a person of ordinary skill in the relevant art to practice the invention, including making and using any devices and performing any incorporated methods. The patentable scope of the invention is defined by the claims, and may include other examples that occur to those person of ordinary skill in the art. Such other examples are intended to be within the scope of the claims if they have structural elements that do not differ from the literal language of the claims, or if they include equivalent structural elements with insubstantial differences from the literal language of the claims.

Further, multiple variations and modifications are possible in the embodiments of the invention described here. Although a certain illustrative embodiment of the invention has been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

I claim:

1. A portable electronic device that receives information wirelessly broadcasted over a plurality of first radio frequency bands and demodulates, amplifies, and wirelessly over a plurality of second radio frequency bands rebroadcasts said information to at least one of a plurality of wireless electronic devices, and simultaneously, or alternatively, to at least one of a plurality of cable-compatible electronic devices tethered to said portable electronic device by an equal number of cables, the portable electronic device comprising:
(a) a power supply;
(b) a central processing unit;
(c) computer-readable media communicating with said central processing unit;
(d) input and output devices communicating with the central processing unit;
(e) ports to attach the cable-compatible electronic devices to the portable electronic device;
(f) a subscriber identity module to communicate with the central processing unit;
(g) a user interface; and
(h) software resident on said computer-readable media;
whereby said software enables the portable electronic device to receive the information and rebroadcast the information while stationary in a building, or in a vehicle at rest or moving at up to posted speeds if over-the-road or over-the-rails or underway if over-the-water.

2. A method of receiving information by a portable electronic device wirelessly broadcasted over a plurality of first radio frequency bands, demodulating, amplifying, and wirelessly over a plurality of second radio frequency bands rebroadcasting said information to at least one of a plurality of wireless electronic devices, and simultaneously, or alternatively, to at least one of a plurality of cable-compatible electronic devices tethered to said portable electronic device by an equal number of cables, comprising the steps of:
(a) energizing a central processing unit resident in the portable electronic device;
(b) pre-loading software to computer-readable media from a user interface;
(c) activating input and output devices to communicate with said central processing unit;
(d) connecting said cable-compatible electronic devices to the portable electronic device;
(e) activating a subscriber identity module to communicate with the central processing unit; and
(f) accessing said software on said computer-readable media by the central processing unit;
whereby the software enables the portable electronic device to receive the information and rebroadcast the information while stationary in a building, or in a vehicle at rest or moving at up to posted speeds if over-the-road or over-the-rails or underway if over-the-water.

3. A portable electronic device which, when located in a vehicle moving over-the-road or over-the-rails at posted speeds or underway over-the-water, determines the position, measured as latitude and longitude, of a wi-fi gateway/controller or access point broadcasting in wi-fi frequency bands by connecting to and disconnecting from said wi-fi gateway/controller or access point within range of said portable electronic device, while said vehicle is traveling past the wi-fi gateway/controller or access point, the portable electronic device comprising:
(a) a power supply;
(b) a central processing unit;
(c) computer-readable media communicating with said central processing unit;
(d) input and output devices communicating with the central processing unit;
(e) a global navigation satellite system receiver to communicate with the central processing unit;
(f) a subscriber identity module to communicate with the central processing unit;
(g) a user interface; and
(h) software resident on said computer-readable media, wherein;
(1) a first program mathematically calculates the latitude and longitude of the wi-fi gateway/controller or access point within broadcast range of the portable electronic device by using the latitude and longitude of the position of the vehicle passing by the wi-fi gateway/controller or access point at two different times;
(2) a second program mathematically calculates the periphery of the region surrounding the wi-fi gateway/controller or access point that exceeds a minimum level of signal strength;
(3) a third program assigns a unique alphanumeric identifier to the wi-fi gateway/controller or access point whose latitude and longitude is now calculated and saves to memory said unique alphanumeric identifier, the latitude and longitude, and other data describing the capabilities of the wi-fi gateway/controller or access point; and
(4) a fourth program uploads the unique alphanumeric identifier, the latitude and longitude, and other data describing the capabilities of the wi-fi gateway/controller or access point to a central data collection point;
whereby said central data collection point saves the unique alphanumeric identifier, the latitude and longitude, and other data describing the capabilities of the wi-fi gateway/controller or access point for download to other portable electronic devices whose users purchase or subscribe to a service which shares the unique alphanumeric identifier, the latitude and longitude, and other data describing the capabilities of the wi-fi gateway/controller or access point.

4. A method of determining the position, measured as latitude and longitude, of a wi-fi gateway/controller or access point broadcasting in wi-fi frequency bands, by a portable electronic device connecting to and disconnecting from said wi-fi gateway/controller or access point within range of said portable electronic device, when the portable electronic device is located in a vehicle traveling past the wi-fi gateway/controller or access point over-the-road or over-the-rails at posted speeds or underway over-the-water, comprising the steps of:
(a) energizing a central processing unit resident in the portable electronic device;
(b) pre-loading software to computer-readable media from a user interface;
(c) activating input and output devices to communicate with said central processing unit;
(d) activating a global navigation satellite system receiver to communicate with the central processing unit;
(e) activating a subscriber identity module to communicate with the central processing unit; and
(f) loading said software from said computer-readable media to the central processing unit, wherein;
(1) a first program mathematically calculates the latitude and longitude of the wi-fi gateway/controller or access point within broadcast range of the portable electronic device by using the latitude and longitude of the position of the vehicle passing by the wi-fi gateway/controller or access point at two different times;
(2) a second program mathematically calculates the periphery of the region surrounding the wi-fi gateway/controller or access point that exceeds a minimum level of signal strength;
(3) a third program assigns a unique alphanumeric identifier to the wi-fi gateway/controller or access point whose latitude and longitude is now calculated and saves to memory said unique alphanumeric identifier, the latitude and longitude, and other data describing the capabilities of the wi-fi gateway/controller or access point;
(4) a fourth program saves to the computer-readable media the unique alphanumeric identifier, the latitude and longitude, and other data describing the capabilities of the wi-fi gateway/controller or access point;
(g) uploading from the computer-readable media to a central data collection point the unique alphanumeric identifier, the latitude and longitude, and other data describing the capabilities of the wi-fi gateway/controller or access point; and
(h) making available for download from said central data collection point to users of the portable electronic device who purchase or subscribe to a service which shares the unique alphanumeric identifier, the latitude and longitude, and other data describing the capabilities of the wi-fi gateway/controller or access point.

5. A portable electronic device which, when located in a vehicle moving over-the-road or over-the-rails at posted speeds or underway over-the-water, seamlessly connects to and disconnects from contiguous wi-fi gateway/controllers or access points broadcasting information in wi-fi frequency bands within range of said portable electronic device, and while receiving said information, wirelessly rebroadcasts the information to at least one of a plurality of wi-fi-compatible electronic devices, and simultaneously, or alternatively, to at least one of a plurality of cable-compatible electronic devices tethered to the portable electronic device by an equal number of cables, the portable electronic device comprising:
(a) a power supply;
(b) a central processing unit;
(c) computer-readable media communicating with said central processing unit;
(d) input and output devices communicating with the central processing unit;
(e) ports to attach said cable-compatible electronic devices to the portable electronic device;
(f) a global navigation satellite system receiver communicating with the central processing unit;
(g) a subscriber identity module to communicate with the central processing unit;
(h) a user interface; and
(i) software resident on said computer-readable media, wherein;
(1) a first program permits a user to download from a central data collection point to the portable electronic device a unique alphanumeric identifier, the latitude and longitude, and other data describing the capabilities of said contiguous wi-fi gateway/controllers or access points;
(2) a second program detects when the portable electronic device crosses the periphery of the region surrounding a first one of the contiguous wi-fi gateway/controllers or access points where the signal strength is equal to or above a minimum level of signal strength;
(3) a third program detects that once the portable electronic device crosses the periphery of said region surrounding said first one of the contiguous wi-fi gateway/controllers or access points, the portable electronic device automatically connects to the first one of the contiguous wi-fi gateway/controllers or access points and remains connected while the portable electronic device is within the region surrounding the first one of the contiguous wi-fi gateway/controllers or access points;
(4) a fourth program detects that once the portable electronic device exits the periphery of the region surrounding the first one of the contiguous wi-fi gateway/controllers or access points and crosses the periphery of the region surrounding a second one of the contiguous wi-fi gateway/controllers or access points, the portable electronic device automatically disconnects from the first one of the contiguous wi-fi gateway/controllers or access points and connects to said second one of the contiguous wi-fi gateway/controllers; and remains connected while the portable electronic device is within the region surrounding the second one of the contiguous wi-fi gateway/controllers or access points;
whereby the information is rebroadcast to at least one of the wi-fi-compatible electronic devices, and simultaneously, or alternatively, to at least one of the cable-compatible electronic devices, while maintaining acceptable levels of quality of service and quality of experience.

6. A method of seamlessly connecting to and disconnecting from contiguous wi-fi gateway/controllers or access points broadcasting information in wi-fi frequency bands within range of a portable electronic device, when said portable electronic device is located in a vehicle moving over-the-road or over-the-rails at posted speeds or underway over-the-water, and while receiving said information, wirelessly rebroadcasts the information to wi-fi-compatible electronic devices, and simultaneously, or alternatively, to at least one cable-compatible electronic device tethered to the portable electronic device by an equal number of cables, comprising the steps of:
(a) energizing a central processing unit resident in the portable electronic device;
(b) pre-loading software to computer-readable media from a user interface;
(c) activating input and output devices to communicate with said central processing unit;
(d) connecting cable-compatible electronic devices to the portable electronic device;
(e) activating a global navigation satellite system receiver to communicate with the central processing unit;
(f) activating a subscriber identity module to communicate with the central processing unit;
(g) loading said software from said computer-readable media to the central processing unit, wherein;
(1) a first program permits a user to download from a central data collection point to the portable electronic device a unique alphanumeric identifier, the latitude and longitude, and other data describing the capabilities of at least two of said contiguous wi-fi gateway/controllers or access points;
(2) a second program detects when the portable electronic device crosses the periphery of the region surrounding a first one of the contiguous wi-fi gateway/controllers or access points where the signal strength is equal to or above a minimum level of signal strength;
(3) a third program detects that once the portable electronic device crosses the periphery of said region surrounding said first one of the contiguous wi-fi gateway/controllers or access points, the portable electronic device automatically connects to the first one of the contiguous wi-fi gateway/controllers or access points and remains connected while the portable electronic device is within the region surrounding the first one of the contiguous wi-fi gateway/controllers or access points;
(4) a fourth program detects that once the portable electronic device exits the periphery of the region surrounding the first one of the contiguous wi-fi gateway/controllers or access points and crosses the periphery of the region surrounding a second one of the contiguous wi-fi gateway/controllers or access points, the portable electronic device automatically disconnects from the first one of the contiguous wi-fi gateway/controllers or access points and connects to a second one of the contiguous wi-fi gateway/controllers or access points and remains connected while the portable electronic device is within the region surrounding the second one of the contiguous wi-fi gateway/controllers or access points; and remains connected while the portable electronic device is within the region surrounding the second one of the contiguous wi-fi gateway/controllers or access points;
whereby the information is rebroadcast to at least one of the wi-fi-compatible electronic devices, and simultaneously, or alternatively, to the cable-compatible electronic devices, while maintaining acceptable levels of quality of service and quality of experience.

7. Claims 1 and 2 wherein the first radio frequency bands comprise:
(a) over-the-air digital television frequency bands;
(b) 2.4 GHz wi-fi frequency bands;
(c) 5 GHz wi-fi frequency bands;
(d) cellular frequency bands; or
(e) personal communications service frequency bands.

8. Claims 1 and 2 wherein the second radio frequency bands comprise:
(a) 2.4 GHz wi-fi frequency bands;
(b) 5 GHz wi-fi frequency bands;
(c) cellular frequency bands; or
(d) personal communications service frequency bands.

9. Claims 1 and 2 wherein the wireless electronic devices comprise:
(a) smartphone;
(b) smart thermostat;
(c) smart doorbell;
(d) smart lock;
(e) smart refrigerator;
(f) laptop computer;
(g) tablet computer;
(h) smart television; or
(i) bluetooth device.

10. Claims 1 and 2 wherein the cable-compatible electronic devices comprise:
(a) digital video recorder;
(b) smartphone;
(b) smart television; or
(c) desktop computer.

11. Claims 1, 2, 5, and 6 wherein the cables comprise:
(a) a micro universal service bus cable;
(b) a universal service bus cable;
(c) a high-definition multimedia interface cable; or
(d) an ethernet cable.

12. Claims 1, 3, and 5 wherein the power supply comprises:
(a) a single phase nominal 115-volt AC/DC transformer for energizing a portable electronic device;
(b) an internal battery; and
(c) a retractable solar panel with nominal dimensions of 70 mm long, 65 mm wide, and 3 mm thick, output voltage of 4 V, and power current of 100 mA.

13. Claims 1, 2, 3, 4, 5, and 6 wherein the central processing unit comprises:
(a) at least a 3 GHz clock speed;
(b) a quad-core processor; and
(c) a 64-bit operating system.

14. Claims 1, 2, 3, 4, 5, and 6 wherein the computer-readable media comprises:
(a) read only memory with at least sufficient storage capacity to bootstrap the portable electronic device;
(b) at least 8 GB of double data rate type three synchronous dynamic random-access memory; and
(c) at least 500 GB solid state non-volatile memory chipset.

15. Claims 1, 2, 3, 4, 5, and 6 wherein the input and output devices comprise:
(a) a system on a chip for receiving and demodulating over-the-air digital television signals capable of receiving high-definition audio, video and graphics back-end for current and future digital television access;
(b) a fish-eye camera connected to a high definition 720p camera system on a chip;
(c) a 2.4/5 GHz 802.11ac system on a chip with four multiple-in, multiple-out antennas which supports IEEE 802.11a, 802.11b, 802.11g, 802.11n, and 802.11ac wi-fi compatible hardware;
(d) a personal computer sound card connected to a miniature microphone and speaker;
(e) a small cell system on a chip for cellular access for enterprise markets with at least the following features; a 3G, 4G, and 4G/LTE small-cell transceiver; supporting multiple networks and configurations, including, third generation time division—synchronous code division multiple access and wideband code division multiple access long term evolution in frequency division duplexing and time division duplexing, and carrier wireless local area network with dedicated wireless local area network processor core;
(f) at least two antennae connectors each with 50Ω impedance with attached equal number of wi-fi whip antennae;
(g) at least one coaxial radio frequency connector with attached equal number of short whip antenna to capture over-the-air digital television signals;
(h) one or more status lights comprising:
(1) a light showing the status of the amount of electrical charge in the battery supplying power to the portable electronic device;
(2) a light showing if wi-fi protected setup is enabled;
(3) a light showing the status of the user interface;
(4) a light showing the status of the over-the-air television program;
(5) a light showing the status of the wi-fi program;
(6) a light showing the status of the cellular data reception program;
(7) a light showing the status of the cabling program;
(8) a light showing the status of the blue tooth program;
(9) a light showing if the global navigation satellite system receiver is enabled; or
(10) a light showing if the wi-fi gateway/controller or access point mapping program is enabled.

16. Claims 3, 4, 5, and 6 wherein the global navigation satellite system receiver comprises an integrated sensor hub, which supports frequencies L1 and L5, and capable of simultaneously receiving at least the following signals: L1 C/A, L5 and L1 C, providing positional accuracy within +/−1 meter of actual position.

17. Claims 1 and 5 wherein the ports comprise one or more of:
(a) a port for connecting a micro universal service bus cable;
(b) a port for connecting a universal service bus cable;
(c) a port for connecting a high-definition multimedia interface cable; or
(d) a port for connecting an ethernet cable.

18. Claims 1 and 2 wherein the first radio frequency bands comprise;
(a) over-the-air digital television frequency bands;
(1) 54 MHz to 88 MHz comprising channels 2 to 6;
(2) 174 MHz to 216 MHz comprising channels 7 to 13;
(3) 470 MHz to 608 MHz comprising channels 14 to 36;
(4) 614 MHz to 710 MHz comprising channels 38 to 53;
(5) 716 MHz to 740 MHz comprising channels 55 to 58;
(6) 758 MHz to 776 MHz comprising channels 62 to 64;
(b) nominal 2.4 GHz frequency band comprising;
(1) 2,401 MHz to 2,473 MHz in channels 1 to 11;
(c) nominal 5 GHz frequency band comprising;
(1) 5,170 MHz to 5,330 MHz in channels 36, 40, 44, 48, 52, 56, 60, and 64 at 20 MHz bandwidth;
(2) 5,490 MHz to 5,730 MHz in channels 100, 104, 108, 112, 116, 120, 124, 128, 132, 136, 140, and 144 at 20 MHz bandwidth;
(3) 5,735 MHz to 5,815 MHz in channels 149, 153, 157, and 161 at 20 MHz bandwidth;
(d) cellular frequency bands comprising;
(1) 824 to 849 MHz and 869 to 894 MHz in the cellular band; and
(2) 1850 to 1990 MHz in the personal communications service band.

19. Claims 1 and 2 wherein the second radio frequency bands comprise;
(a) nominal 2.4 GHz frequency band comprising;
(1) 2,401 MHz to 2,473 MHz in channels 1 to 11;
(b) nominal 5 GHz frequency band comprising;
(1) 5,170 MHz to 5,330 MHz in channels 36, 40, 44, 48, 52, 56, 60, and 64 at 20 MHz bandwidth;
(2) 5,490 MHz to 5,730 MHz in channels 100, 104, 108, 112, 116, 120, 124, 128, 132, 136, 140, and 144 at 20 MHz bandwidth;
(3) 5,735 MHz to 5,815 MHz in channels 149, 153, 157, and 161 at 20 MHz bandwidth;
(c) cellular frequency bands comprising;
(1) 824 to 849 MHz and 869 to 894 MHz in the cellular band; and
(2) 1850 to 1990 MHz in the personal communications service band.

20. Claims 3, 4, 5, and 6 wherein the wi-fi frequency bands comprise;
(a) nominal 2.4 GHz frequency band comprising;
(1) 2,401 MHz to 2,473 MHz in channels 1 to 11;
(b) nominal 5 GHz frequency band comprising;
(1) 5,170 MHz to 5,330 MHz in channels 36, 40, 44, 48, 52, 56, 60, and 64 at 20 MHz bandwidth;
(2) 5,490 MHz to 5,730 MHz in channels 100, 104, 108, 112, 116, 120, 124, 128, 132, 136, 140, and 144 at 20 MHz bandwidth;
(3) 5,735 MHz to 5,815 MHz in channels 149, 153, 157, and 161 at 20 MHz bandwidth.

21. Claims 1, 2, 3, 4, 5, and 6 wherein the subscriber identity module comprises;
(a) a full-size subscriber identity module;
(b) a mini-subscriber identity module;
(c) a micro-subscriber identity module;
(d) a nano-subscriber identity module; or
(e) an imbedded subscriber identity module.

22. Claims 5 and 6 wherein the wi-fi-compatible electronic devices comprise:
(a) smartphone;
(b) smart thermostat;
(c) smart doorbell;
(d) smart lock;
(e) smart refrigerator;
(f) laptop computer;
(g) tablet computer;
(h) smart television; or
(i) bluetooth device.

23. Claims 3, 4, 5, and 6 wherein the minimum level of signal strength is greater than or equal to −75 decibel-milliwatts.
